(19) United States
(12) Patent Application Publication
(10) Pub. No.: US 2025/0019473 A1
(43) Pub. Date: Jan. 16, 2025

(54) QUINONE-CONTAINING POLYMER, METHODS FOR THE MANUFACTURE THEREOF, AND USE FOR ELECTROCHEMICAL GAS SEPARATION

(71) Applicant: Verdox, Inc., Woburn, MA (US)

(72) Inventors: Cameron Rogers, Malden, MA (US); Sahag Voskian, Boston, MA (US)

(21) Appl. No.: 18/712,366

(22) PCT Filed: Nov. 23, 2022
(86) PCT No.: PCT/US2022/050836

§ 371 Date: May 22, 2024

Related U.S. Application Data
(60) Provisional application No. 63/282,779, filed on Nov. 24, 2021.

(51) Int. Cl. C08F 16/36; B01D 53/32; C25B 13/08

(52) U.S. Cl. CPC C08F 16/36; B01D 53/326; C25B 13/08

(57) ABSTRACT

A quinone-containing polymer includes repeating units of at least one of Formulas (I) to (IV) or a hydrogenated derivative thereof, as defined herein. Methods of manufacturing the quinone-containing polymer are also disclosed. The quinone-containing polymer can be useful in composites, electrode assemblies, electrochemical cells, gas separation systems, energy storage devices, and electrochromic devices.

### CROSS REFERENCE TO RELATED APPLICATION

This application claims priority to U.S. Provisional Patent Application No. 63/282,779, filed on Nov. 24, 2021, in the United States Patent and Trademark Office, and all the benefits accruing therefrom under 35 U.S.C. § 119, the content of which is incorporated herein in its entirety by reference.

### BACKGROUND

Removing target species from gas mixtures has been the subject of much research and development. For example, there have been efforts to mitigate global warming by curbing carbon dioxide emissions. To this end, a number of approaches, such as thermal methods have been explored, to capture carbon dioxide at different stages of its production.

Other potential applications of target gas removal include removing target gases directly from air or ventilated air.

Electro-swing adsorption (ESA) is an alternative method of capturing a target gas from a gaseous mixture. Typically, the electrode in an electro-swing adsorption cell includes an electrically conductive scaffold and an electroactive material. There remains a need for improved materials for electro-swing adsorption, including improved methods of production.

### SUMMARY

A quinone-containing polymer comprises repeating units of at least one of Formulas (I) to (IV) or a hydrogenated derivative thereof

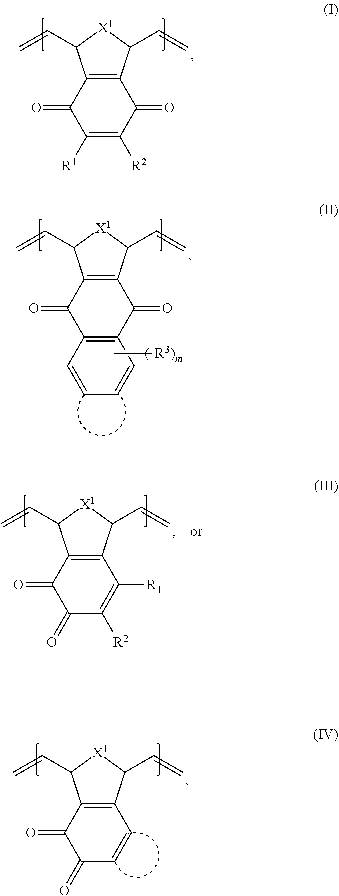

wherein in Formulas (I) to (IV), X¹ is —CH₂— or —O—; X² is —CH₂— or —O—; X³ is —CH₂— or —O—; X⁴ is —CH₂— or —O—; R¹ and R² are independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group; R³ is independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, or a thiol group, an amine group, an amide group, an ester group, or a ketone group; m is 2 to 4; and the dashed lines of Formulas (II) and (IV) indicate the optional presence of one or more additional fused substituted or unsubstituted aryl groups; provided that when X¹ is —CH₂—, at least one of R¹ and R² is not hydrogen.

A method of making a quinone-containing polymer comprises polymerizing a quinone-containing monomer of Formulas (IX) to (XII)

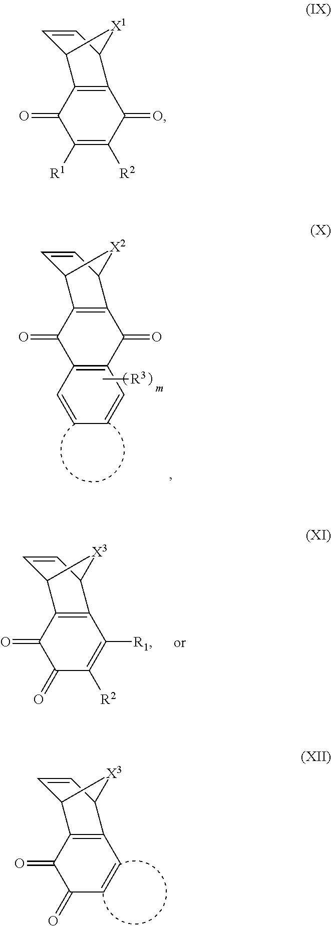

in the presence of an olefin metathesis catalyst under conditions effective to provide a quinone-containing polymer comprising repeating units of Formulas (I) to (IV) or a hydrogenated derivative thereof

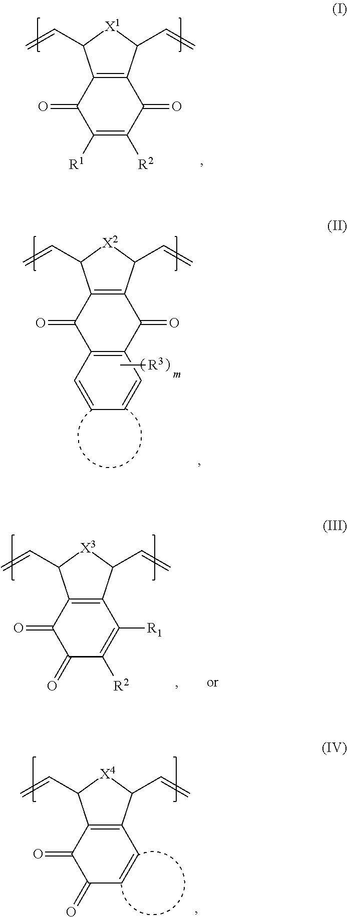

wherein in in the foregoing Formulas, X¹ is —CH₂— or —O—; X² is —CH₂— or —O—; X³ is —CH₂— or —O—; X⁴ is —CH₂— or —O—; R¹ and R² are independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group; R³ is independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group; m is 2 to 4; and the dashed lines of Formula (II), (IV), (XI), and (XII) indicate the optional presence of one or more additional fused substituted or unsubstituted aryl groups.

A composite comprising a quinone-containing polymer disposed on a substrate, wherein the quinone-containing polymer comprises repeating units of at least one of Formula (I) to (IV)

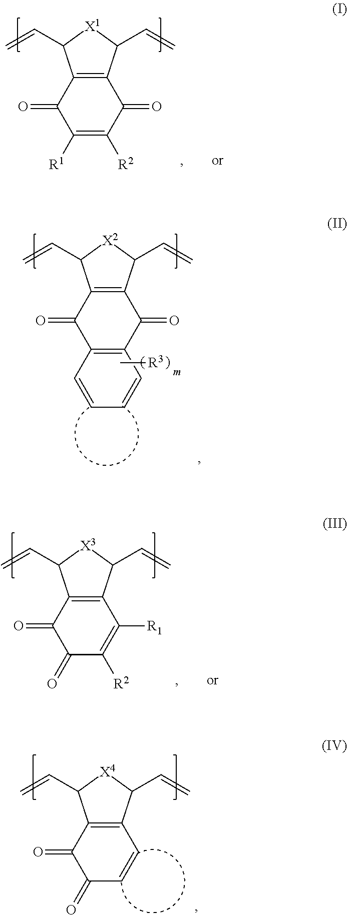

wherein in Formulas (I) to (IV), X¹ is —CH₂— or —O—; X² is —CH₂— or —O—; X³ is —CH₂— or —O—; X⁴ is —CH₂— or —O—; R¹ and R² are independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group; R³ is independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group; m is 2 to 4; and the dashed lines of Formula (II) and (IV) indicate the optional presence of one or more additional fused substituted or unsubstituted aryl groups.

An electrode assembly comprises a porous separator and the composite on a surface of the porous separator, in a pore of the porous separator, or a combination thereof.

An electrochemical cell comprises the composite.

A gas separation system comprises a plurality of electrochemical cells in fluid communication with a gas inlet and a gas outlet.

An energy storage device comprises the quinone-containing polymer, the composite, or the electrochemical cell.

An electrochromic device comprises the quinone-containing polymer, the composite, or the electrochemical cell.

A method for separating a target gas from a fluid mixture comprising the target gas comprises contacting the fluid mixture with a quinone-containing polymer comprising repeating units according to Formulas (I) to (IV) or a hydrogenated derivative thereof, wherein the quinone-containing polymer is in a reduced state, to form an anion adduct between the target gas and the quinone-containing polymer in the reduced state.

The above described and other features are exemplified by the figures and detailed description.

### BRIEF DESCRIPTION OF THE DRAWINGS

The following figures are exemplary embodiments.

FIG. 1 is a chemical scheme illustrating the synthesis of poly(1,4-dihydro-1,4-methano-6,7-dimethylnaphthalene-5,8-dione).

FIG. 2 is a chemical scheme illustrating the synthesis of poly(1,4-dihydro-1,4-methanonaphthalene-5,8-dione).

FIG. 3 is a chemical scheme illustrating the synthesis of poly(1,4-dihydro-1,4-methanoanthracene-9,10-dione).

### DETAILED DESCRIPTION

Several redox-active polymers have been explored as electroactive materials, particularly those including quinone moieties, which can switch between oxidized and reduced states having differing affinities for a target gas. It has been found that certain quinone-containing polymers can be prepared by ring-opening metathesis polymerization (ROMP) and have desirable properties as redox-active materials. As such, these materials may be suitable for electro-swing adsorption (ESA) gas separation, organic polymer batteries, and other applications. ROMP is a highly controlled living polymerization technique that offers excellent synthetic control over polymer structure and molecular weight with good functional group tolerance. Extension of ROMP to quinone-containing structures would afford ready access to a versatile class of redox-active polymers. Certain quinone-containing monomers have been previously shown to not tolerate polymerization with ruthenium-containing ROMP catalysts.

Accordingly, there remains a need in the art for an alternative synthetic approach to enable the use of quinone-containing ROMP polymers, in particular for ESA applications. The present inventors have surprisingly discovered that quinone-containing ROMP polymers can be prepared with olefin metathesis catalysts, such as Schrock-type molybdenum or tungsten alkylidene catalysts. The quinone-containing ROMP polymers of the present disclosure can be particularly useful for a variety of electrochemical applications, including, but not limited to, energy storage, electrochromic applications, and gas separation.

In a specific aspect, the quinone-containing polymers can be used in electrode assemblies, electrochemical cells, and gas separation systems to separate a target gas (e.g., CO₂ or SO₂) from a gas mixture by an electrochemical process. Thus, a significant improvement is provided by the present disclosure.

Accordingly, an aspect of the present disclosure is a quinone-containing polymer, also referred to as a “polyquinone” for brevity. The polyquinone is a polymer which, as defined herein, includes at least 5 repeating units according to Formula (I), (II), (III), or (IV), a hydrogenated derivative thereof, or a combination thereof. Preferably, the polyquinone comprises at least 10 repeating units according to Formula (I), (II), (III), or (IV), or a combination thereof, for example 5 to 100 repeating units, or 10 to 100 repeating units, or 10 to 75 repeating units, or 10 to 50 repeating units, or 10 to 30 repeating units or 10 to 25 repeating units.

The polyquinone comprises repeating units wherein a quinone-containing moiety is fused to a cyclic olefin which can be polymerized by ROMP. The polyquinone comprises repeating units of at least one of Formula (I) to (IV):

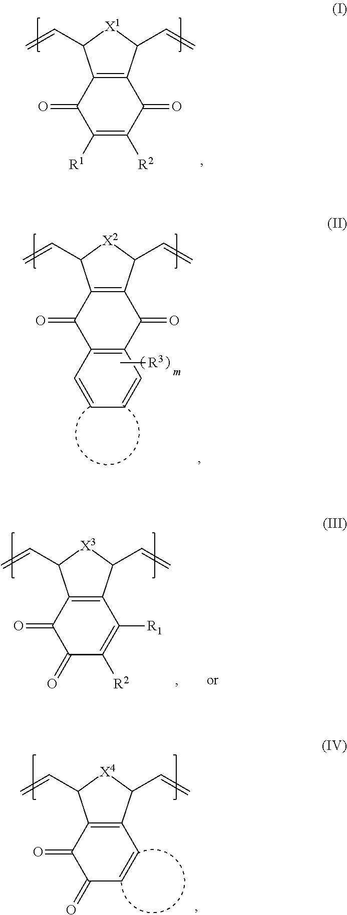

wherein in Formulas (I) to (IV), X¹ is —CH₂— or —O—; X² is —CH₂— or —O—; X³ is —CH₂— or —O—; X⁴ is —CH₂— or —O—; R¹ and R² are independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group; R³ is independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, or a thiol group, an amine group, an amide group, an ester group, or a ketone group; m is 2 to 4; and the dashed lines of Formula (II) or (IV) indicate the optional presence of one or more additional fused substituted or unsubstituted aryl groups. When X¹ of Formula (I) is —CH₂—, at least one of R¹ and R² is not hydrogen. When R³ comprises an amine group, the amine group can be of the formula —NR′R″, wherein R′ and R″ are independently at each occurrence hydrogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, for example a substituted or unsubstituted C₁₋₆ alkyl group, such as a methyl group (e.g., —N(CH₃)₂).

As will be understood by the skilled person, the identity of R¹, R², and R³ can be influenced by the conditions used to prepare the polyquinones. For example, some functional groups, such as thiols or amines, may poison certain ROMP catalysts and not others. Thus, the skilled person knows how to select suitable functional groups for substituents R¹, R², and R³ guided by the present disclosure and based on the functional group tolerance of the catalyst selected to prepare the polyquinone.

In an aspect, the polyquinone can comprise repeating units according to Formula (I). In an aspect, the polyquinone can comprise repeating units according to Formula (I) wherein X¹ is —CH₂— and at least one of R¹ and R² is not hydrogen. For example, R can be hydrogen and R² can be halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group. In an aspect, X¹ is —CH₂— and at least one of R¹ and R² is a substituted or unsubstituted C₁₋₆ alkyl group. In an aspect, X¹ is —CH₂— and R¹ and R² are each a substituted or unsubstituted C₁₋₆ alkyl group, preferably R¹ and R² are each a methyl group.

In an aspect, the polyquinone can comprise repeating units according to Formula (I) wherein X¹ is —O—. R¹ and R² can each independently be hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group. For example, R¹ and R² can each be hydrogen.

In an aspect, the polyquinone can comprise repeating units according to Formula (II). In an aspect, the polyquinone can comprise repeating units according to Formula (II) and X² is —CH₂— or —O—, m is 4, and no additional fused substituted or unsubstituted aryl groups are present. In an aspect, m can be 4 and each occurrence of R³ can be a halogen (e.g., chlorine).

In an aspect, the polyquinone can comprise repeating units according to Formula (II) and X² is —CH₂— or —O—, m is 2, and the polymer comprises repeating units of Formula (V)

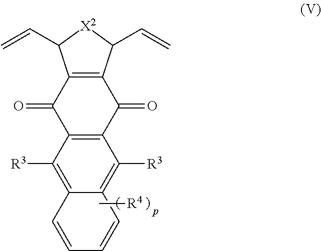

wherein p is 0 to 4 and R⁴ is independently at each occurrence halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group. When p is 0, it is understood that the valence of the phenyl ring is filled with hydrogen. In an aspect, the polyquinone can be according to Formula (V) and each occurrence of R³ can be hydrogen and p is 0. In an aspect, X² can be —CH₂—. In an aspect, X² can be —CH₂—, each occurrence of R³ can be hydrogen and p can be 0.

In an aspect, the polyquinone can comprise repeating units according to Formula (III). In an aspect, the polyquinone can comprise repeating units according to Formula (III) wherein X³ is —CH₂—. In an aspect, X³ is —CH₂— and at least one of R¹ and R² is a substituted or unsubstituted C₁₋₆ alkyl group. In an aspect, X³ is —CH₂— and R¹ and R² are each a substituted or unsubstituted C₁₋₆ alkyl group, preferably R¹ and R² are each a methyl group. In an aspect, the polyquinone can comprise repeating units according to Formula (III) wherein X³ is —O—. R¹ and R² can each independently be hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group. For example, R¹ and R² can each be hydrogen.

In an aspect, the polyquinone can comprise repeating units according to Formula (IV). In an aspect, the polyquinone can comprise repeating units according to Formula (IV) wherein X⁴ is —CH₂—. In an aspect, the polyquinone can comprise repeating units according to Formula (IV) wherein X¹ is —O—.

In an aspect, the polyquinone can comprise hydrogenated repeating units of at least one of Formulas (I) to (IV). The hydrogenated repeating units can be according to Formula (Ia) to (IVa)

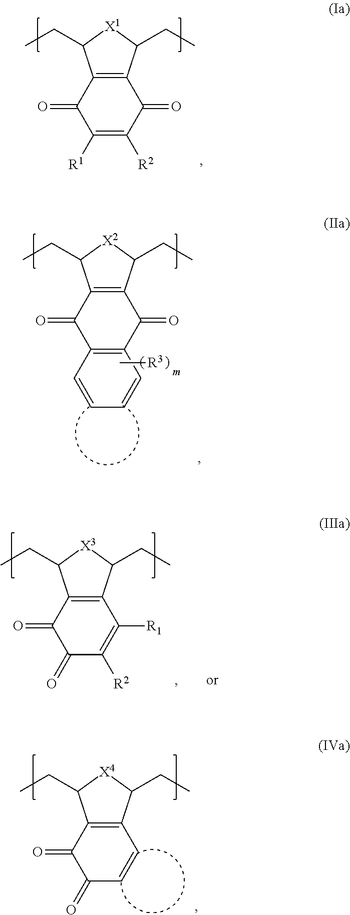

wherein the hydrocarbon backbone has been at least partially hydrogenated. In an aspect, the polyquinone can be at least 10% hydrogenated, meaning that at least 10% of the double bonds of the polymer backbone have been hydrogenated to single bonds. In an aspect, the polyquinone can be at least 20% hydrogenated, or at least 50% hydrogenated, or at least 75% hydrogenated, or at least 90% hydrogenated. In an aspect, the polyquinone backbone can be completely hydrogenated (i.e., 100% of the double bonds of the polymer backbone have been converted to single bonds).

In an aspect, at least 10 mole percent, or at least 20 mole percent, or at least 30 mole percent, or at least 40 mole percent, or at least 50 mole percent, or at least 75 mole percent, or at least 80 mole percent, or at least 90 mole percent, or at least 95 mole percent, or at least 99 mole percent, e.g., 50 mole percent to 99.9 mole percent, or 75 mole percent to 95 mole percent, of the repeating units are according to at least one of Formulas (I) to (IV). In an aspect, the polyquinone is a homopolymer consisting of repeating units according to Formulas (I), (II), (III), or (IV).

In an aspect, the quinone-containing polymer is a copolymer further comprising one or more repeating units different from the repeating units of Formula (I) to (IV). In an aspect, when present, the repeating units different from the repeating units of Formulas (I) to (IV) can be present in an amount of at most 90 mole percent, or at most 80 mole percent, or at most 70 mole percent, or at most 60 mole percent, or at more 50 mole percent, or at most 25 mole percent, or at most 20 mole percent, or at most 10 mole percent, or at most 5 mole percent.

The additional repeating units can generally be derived from any monomer that is polymerizable by ROMP. Preferably the additional repeating units are derived from a norbornene- or oxanorbornene-containing monomer. The additional repeating units can preferably be selected to impart a desired property or functionality to the polyquinone. For example, the one or more repeating units can comprise a crosslinkable group, an adhesion promoting group, a solubilizing group, or a combination thereof.

Crosslinkable groups can include functional groups which are triggered by heat, radiation, or a chemical trigger suitable for forming a crosslinked network comprising the polyquinone. The crosslinkable group can generally be any functional group capable of participating in a chemical reaction with a complementary functional group. Crosslinks formed from the crosslinkable groups can include ionic bonds, covalent bonds, or a combination thereof. Examples of the crosslinkable functional groups can include, but are not limited to, vinyl, azido, epoxy, hydroxy, carboxy, amino, isocyanato, aluminum salts, halides (e.g., benzyl halides), or any combination thereof.

For example, the polyquinone can further comprise repeating units according to Formula (VI), (VII), or a combination thereof

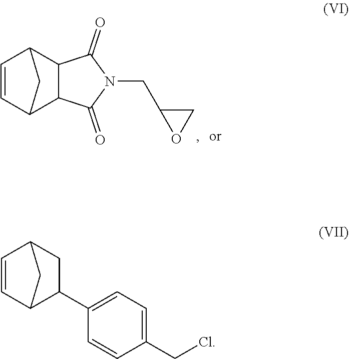

As used herein “adhesion promoting groups” refer to a functional group which can increase interaction between the polyquinone and the surface of a substrate. For example, if the polyquinone is to be disposed on a carbonaceous substrate, it can be desirable to include groups which can interact with said carbonaceous materials, such as a polycyclic aromatic hydrocarbon group (e.g., pyrene). For example, the polyquinone can further comprise repeating units according to Formula (VIII)

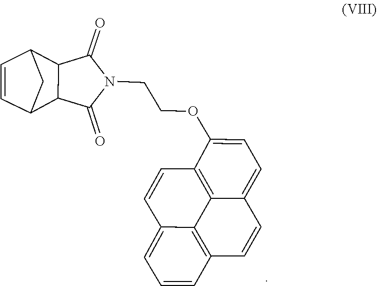

Solubilizing groups as used herein refer to repeating units designed to increase the solubility of the polyquinone in a selected solvent. For example, suitable solubilizing groups can include C₁₋₂₀ alkyl groups or a poly(C₁₋₃₀ alkylene oxide) group (e.g., polyethylene glycol).

The polyquinone can have a number average molecular weight of 1,000 to 1,000,000 grams per mole. Within this range, the polyquinone can have a number average molecular weight of 1,000 to 750,000 grams per mole, or 1,000 to 500,000 grams per mole, or 1,000 to 250,000 grams per mole, 1,000 to 200,000 grams per mole, or 10,000 to 200,000 grams per mole, preferably 10,000 to 100,000 grams per mole, more preferably 10,000 to 75,000 grams per mole, even more preferably 20,000 to 50,000 grams per mole. In an aspect, the polyquinone can have a number average molecular weight of 1,000 to 50,000 grams per mole, or 1,000 to 25,000 grams per mole, or 1,000 to 10,000 grams per mole. Molecular weight can be determined, for example, using gel permeation chromatography (GPC) in tetrahydrofuran relative to polystyrene standards.

The quinone-containing polymers can be made using ring opening metathesis polymerization (ROMP) provided that particular catalysts are used. Accordingly, a method of making a quinone-containing polymer represents another aspect of the present disclosure.

The method comprises polymerizing a quinone-containing monomer of any of Formulas (IX) to (XII):

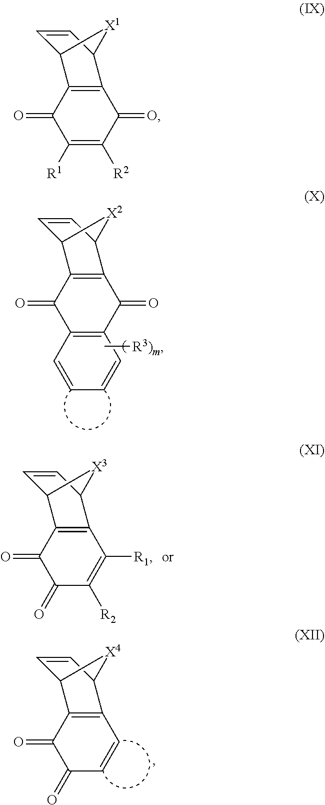

in the presence of an olefin metathesis catalyst under conditions effective to provide a quinone-containing polymer comprising repeating units of Formulas (I) to (IV) or a hydrogenated derivative thereof:

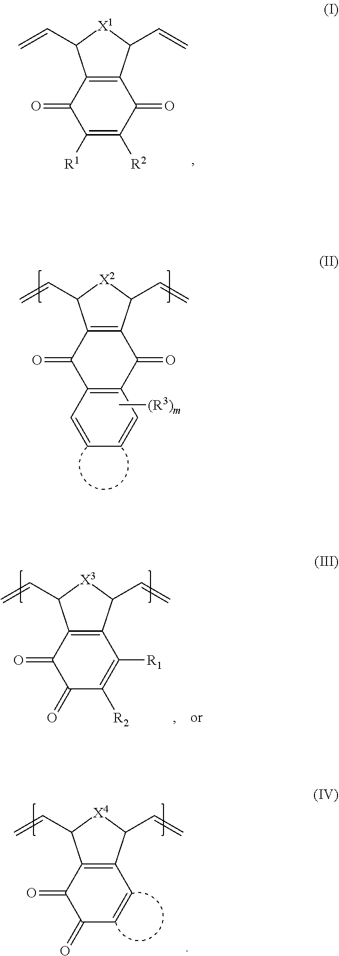

In the foregoing Formulas, X¹ is —CH₂— or —O—; X² is —CH₂— or —O—; X³ is —CH₂— or —O—; X⁴ is —CH₂— or —O—; R¹ and R² are independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group; R³ is independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group; m is 2 to 4; and the dashed lines of Formula (II), (IV), (XI), and (XII) indicate the optional presence of one or more additional fused substituted or unsubstituted aryl groups.

The conditions effective to provide the polyquinone can depend on various features including monomer and catalyst identity.

In an aspect, the olefin metathesis catalyst can be a molybdenum alkylidene catalyst or a tungsten alkylidene catalyst. Exemplary molybdenum alkylidene catalysts or tungsten alkylidene catalysts can include, for example, those described in U.S. Publication No. 2016/0030936, incorporated herein by reference in its entirety. Catalysts can optionally be generated in situ. In an aspect, the catalyst can be a molybdenum alkylidene catalyst. An exemplary molybdenum alkylidene catalyst can include, but is not limited to, a catalyst of the structure

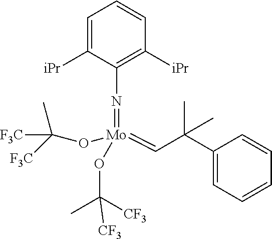

commercially available as X002 from XiMo, AG.

In an aspect, the olefin metathesis catalyst can be a ruthenium-containing catalyst. Particularly useful ruthenium-containing olefin metathesis catalyst can include those which comprise a N-heterocyclic carbene and a chelating ortho-alkoxy benzylidene. Preferably, no phosphine-containing ligands are present in the ruthenium-containing olefin metathesis catalysts. Exemplary catalysts include the second generation Grubbs-Hoveyda catalysts (1,3-Bis-(2,4,6-trimethylphenyl)-2-imidazolidinylidene)dichloro(o-isopropoxyphenylmethylene)ruthenium). Such catalysts are commercially available as Hoveyda-Grubbs Catalyst M720 from Sigma Aldrich.

The conditions effective to provide the quinone-containing polymer can comprise a temperature of 20 to 100° C. and a time of 1 minute to 24 hours, for example 1 to 5 hours, or 2 to 3 hours. In an aspect, the polymerization temperature can be 20 to 80° C. or 20 to 50° C. or 50 to 80° C. In an aspect, the polymerization time can be 1 to 60 minutes, or 1 to 30 minutes, or 1 to 15 minutes.

Polymerization can be conducted in the presence of a solvent. Suitable solvents can be determined based on the solubility of the desired monomer structure. In an aspect, the solvent can be an organic solvent such as toluene, chloroform, chlorobenzene, xylene, N-methylpyrrolidone, and the like, or a combination thereof. In an aspect, the polymerization can be conducted in the absence of water, oxygen or their combination.

The polymerizations can be quenched, for example by addition of a molar excess of an aldehyde. Suitable aldehydes can include but are not limited to benzaldehyde, pivaldehyde, 1-pyrenecarboxaldehyde, and the like, or a combination thereof. The quenching agent determines the chemical structure of the polymer end group, and can therefore, in some aspects, be useful in dictating polymer properties or for further introducing reactive handles for functionalized or telechelic polymers.

The method can optionally further comprise isolating the quinone-containing polymer. Isolation of the quinone-containing polymer can be by, for example, precipitation by addition of an excess of a nonsolvent. An exemplary nonsolvent can include, for example, methanol. Following precipitation, the quinone-containing polymer can be isolated by any solid-liquid separation technique which is generally known, for example, filtration or centrifugation.

In an aspect, the polymerization can be conducted in a solvent which can be useful for subsequent formulation steps, which can be determined based on the desired application. Accordingly, in an aspect, the quinone-containing polymer can be used without further purification or isolation from the polymerization reaction mixture. In an aspect, the polymerization can be purified to remove residual metal catalyst, for example by passing the polymerization solution through a column of adsorbent such as silica or alumina. The purified polymerization mixture can optionally be further used for subsequent formulation steps without isolating the polyquinone from the solvent.

Polymer products can be characterized by nuclear magnetic resonance (NMR) spectroscopy, ultraviolet (UV)-visible spectroscopy, infrared (IR) spectroscopy, and gel permeation chromatography (GPC).

The quinone-containing polymers of the present disclosure can be particularly useful for a variety of electrochemical applications. For example, the quinone-containing polymers described herein can be useful for energy storage, electrochromic applications, catalysis, and gas separation.

A composite comprising the quinone-containing polymer represents another aspect of the present disclosure. The composite can comprise the quinone-containing polymer as described above disposed on a substrate.

The polyquinone can be disposed on at least a portion of a surface of the substrate. In an aspect, the substrate can be impregnated with the polyquinone. In an aspect, one or more intervening layers can be positioned between the substrate and the polyquinone.

In an aspect, no intervening layers are present and the polyquinone can be disposed directly on a surface of the substrate. In an aspect, the substrate can comprise a carbonaceous material. Exemplary carbonaceous material can include, but are not limited to, carbon paper (treated, TEFLON-treated, or untreated), carbon cloth, nonwoven carbon mat, or a nonwoven carbon nanotube mat. In an aspect the substrate can comprise a nonwoven carbon nanotube mat, for example as described in co-pending International Application No. PCT/US2021/049751, the contents of which is incorporated by reference in its entirety for all purposes. In an aspect, the substrate can comprise vertically aligned carbon nanotubes, for example as described in co-pending U.S. Provisional Patent Application No. 63/113,321, the contents of which is incorporated by reference in its entirety for all purposes.

The polyquinone can be referred to as being immobilized on the substrate such that the polyquinone is not capable of freely diffusing away from or dissociating from the substrate. The polyquinone can be immobilized on the substrate in a variety of ways. For example, the polyquinone can be immobilized on the substrate by being bound (e.g., via covalent bonds, ionic bonds, or intramolecular interaction such as electrostatic forces, van der Waals forces, hydrogen bonding, or a combination thereof) to the surface of the substrate. In an aspect, the polyquinone can be immobilized on the substrate by being adsorbed onto a surface of the substrate. In an aspect, the polyquinone can be immobilized on the substrate. Immobilizing the polyquinone can include, but is not limited to, grafting or polymerizing the polyquinone onto a surface of the substrate. “Grafting” as used herein refers to a chemical or electrochemical process producing a covalent bond between the polyquinone and the substrate. In an aspect, the polyquinone can be immobilized on the substrate by being included in a composition, e.g., a coating or a composite layer that is applied or deposited onto the substrate. Immobilizing the polyquinone can also include electrodeposition, plasma deposition, vacuum infiltration, melt coating, or a combination of any of the foregoing.

The thickness of the polyquinone on the surface of the substrate can be, for example, 0.1 to 20 nanometers, or 0.2 to 15 nanometers, or 0.5 to 10 nanometers. The thickness of the polyquinone on the surface of the substrate can depend on the mode of deposition.

The composite can optionally be porous. For example, the composite can have a porosity of at least 20%, preferably 30 to 60%.

The composite can comprise the polyquinone in an amount of 1 to 90 weight percent, based on the total weight of the composite. Within this range, the polyquinone can be present in an amount of at least 2 weight percent, or at least 5 weight percent, or at least 7 weight percent, or least 10 weight percent, at least 20 weight percent, or at least 25 weight percent, or at least 30 weight percent, or least 40 weight percent, or at least 50 weight percent, based on the total weight of the composite. Also within this range, the polyquinone can be present in an amount of at most 85 weight percent, or at most of at most 80 weight percent, or at most 70 weight percent, or at most 60 weight percent, or at most 50 weight percent, or at most 45 weight percent, or at most 40 weight percent. For example, the polyquinone can be present in an amount of 1 to 75 weight percent, or 5 to 60 weight percent, or 7 to 25 weight percent, based on the total weight of the composite.

An electrode assembly represents another aspect of the present disclosure. In an aspect, the electrode assembly comprises the composite as described above and a porous separator. The composite can be disposed on the porous separator, optionally with one or more intervening layers disposed between the composite and the porous separator. In an aspect the composite can be laminated to the porous separator. The porous separator can comprise any suitable material. In an aspect, the porous separator can comprise a polymer film, for example a film comprising a polyamide, a polyolefin, a polyaramid, a polyester, a polyurethane, an acrylic resin, and the like, or a combination thereof. The polymer may be coated on one or both sides with ceramic nanoparticles. In an aspect, the porous separator can comprise cellulose, a synthetic polymeric material, or a polymer/ceramic composite material. Further examples of separators can include polyvinylidene difluoride (PVDF) separators, polytetrafluoroethylene (PTFE), PVDF-alumina composite separators, and the like.

In an aspect, the electrode assembly can comprise a patterned electrode, for example as described in co-pending U.S. application Ser. No. 17/345,074, the contents of which is incorporated by reference in its entirety for all purposes.

An electrochemical cell comprising the quinone-containing polymer represents another aspect of the present disclosure. For example, the electrochemical cell can comprise a first electrode, a second electrode, a separator between the first electrode and the second electrode, and an electrolyte. The quinone-containing polymer of the present disclosure can be present in the electrochemical cell in at least one of the first electrode, the second electrode, the separator, or the electrolyte. In an aspect, a plurality of electrochemical cells can comprise the quinone-containing polymer, where the electrochemical cells are in electronic communication, for example in parallel or in series.

In an aspect, an electrochemical cell can comprise the composite comprising the quinone-containing polymer. For example, the electrochemical cell can comprise a first electrode comprising the above-described composite comprising the polyquinone, a second electrode comprising a complementary electroactive composite layer, and a first separator between the first electrode and the second electrode.

The separator can be as described above for the electrode assembly. The separator can serve as a protective layer that can prevent the respective electrochemical reactions at each electrode from interfering with each other. The separator can also help electronically isolate the first and second electrodes from one another or from other components within the electrochemical cell to prevent a short-circuit. A person of ordinary skill, with the benefit of this disclosure, would be able to select a suitable separator.

The electrochemical cell can further comprise an electrolyte. The electrolyte can have a suitable conductivity at room temperature (e.g., 23° C.). In an aspect the separator can be partially or completely impregnated with the electrolyte. Impregnating the separator with the electrolyte can be by submerging, coating, dipping, or otherwise contacting the separator with the electrolyte. Some or all of the pores of the porous separator can be partially or completely filled with the electrolyte. In an aspect, the separator can be saturated with the electrolyte.

In an aspect the electrolyte comprises an ionic liquid, for example a room temperature ionic liquid (RTIL). Ionic liquids can have low volatility, for example a vapor pressure of less than 10⁻⁵ Pa, or 10⁻¹⁰ to 10⁻⁵ Pa at a temperature of 23° C., which can reduce the risk of the separator drying out and allow for reduction in loss of the electrolyte due to evaporation of entrainment. In an aspect the ionic liquid accounts for substantially all (e.g., at least 80 volume percent, or at least 90 volume percent, or at least 95 volume percent, or at least 98 volume percent, at least 99 volume percent, or at least 99.9 volume percent) of the electrolyte.

The ionic liquid comprises an anion component and a cation component. The anion of the ionic liquid can comprise, but is not limited to halide, sulfate, sulfonate, carbonate, bicarbonate, phosphate, nitrate, nitrate, acetate, PF₆, BF₄, triflate, nonaflate, bis(trifluoromethylsulfonyl)amide, trifluoroacetate, heptafluorobutanoate, haloaluminate, triazolide, or an amino acid derivative (e.g., proline with the proton on the nitrogen removed). The cation of the ionic liquid can comprise one or more of, but is not limited to, imidazolium, pyridinium, pyrrolidinium, phosphonium, ammonium, sulfonium, thiazolium, pyrazolium, piperidinium, triazolium, pyrazolium, oxazolium, guanadinium, an alkali cation, or dialkylmorpholinium. In an aspect, the room temperature ionic liquid comprises an imidazolium as a cation component. In an aspect, the room temperature ionic liquid comprises 1-butyl-3-methylimidazolium (“Bmim”) as a cation component. In an aspect, the room temperature ionic liquid comprises bis(trifluoromethylsulfonyl)imide (“TFSI”) as an anion component. In an aspect, the room temperature ionic liquid comprises 1-butyl-3-methylimidazolium bis(trifluoromethylsulfonyl)imide (“[Bmim][TFSI]”). In an aspect, the room temperature ionic liquid comprises 1-butyl-3-methylimidazolium tetrafluoroborate (“BF₄”) (“[Bmim][BF₄]”).

In an aspect the electrochemical cell of the present disclosure can comprise a first electrode, a second electrode, a separator disposed between the electrodes, and an electrolyte as disclosed above, wherein the polyquinone of the present disclosure can be dissolved in the electrolyte.

The second electrode of the electrochemical cell comprises a complementary electroactive composite layer. The complementary electroactive composite layer can be the same or different from the composite comprising the polyquinone of the present disclosure. The complementary electroactive composite layer comprises an electroactive species which can be the same or different as the polyquinone of the composite of the first electrode.

In an aspect, the complementary electroactive composite layer comprises the same polyquinone as the composite of the first electrode. In an aspect, the complementary electroactive composite layer comprises an electroactive species which is different from the polyquinone of the composite of the first electrode (“a second electroactive species”). The second electroactive species can serve as a source of electrons for the reduction of the first electroactive species present in the first electrode. Likewise, the second electroactive species may serve as a sink for electrons during oxidation of the first electroactive species. The second electroactive species can comprise, for example, polyvinyl ferrocene, poly(3-(4-fluorophenyl)thiophene), or other Faradaic redox species with a reduction potential at least 0.5 volts more positive that the first reduction potential of the first electroactive species (e.g., the polyquinone of the present disclosure).

In an aspect, the second electrode can further comprise a substrate, which can be positioned proximate to or between complementary electroactive composite layers. The substrate can be in direct or indirect contact with the complementary electroactive composite layer or layers. When present, the substrate can include, for example, carbon paper (treated, TEFLON-treated, or untreated), carbon cloth, nonwoven carbon mat, or a nonwoven carbon nanotube mat. In an aspect, the support can comprise the same carbonaceous material of the composite of the first electrode. In an aspect, the substrate of the second electrode can be a conductive material and act as a current collector within the electrochemical cell.

In an aspect, the first electrode can be a negative electrode, and the second electrode can be a positive electrode. The terms negative electrode and positive electrode are used for convenience and clarity, although they may be technically accurate only when the target gas is being acquired or released.

In an aspect, the second electrode can be positioned between first electrodes. Each of the first electrodes can comprise the disclosed composite. In an aspect the first electrodes and/or second electrodes can be identical in configuration or composition.

In an aspect, the electrochemical cell comprises a single separator, disposed between the first electrode and the second electrode, e.g., between the negative electrode and the positive electrode. The separator can serve as a protective layer that can prevent the respective electrochemical reactions at each electrode from interfering with each other. The separator can also help electronically isolate the first and second electrodes from one another or from other components within the electro-swing adsorption cell to prevent a short-circuit. A person of ordinary skill, with the benefit of this disclosure, would be able to select a suitable separator.

In an aspect, the electrochemical cell comprises a single separator, disposed between the first electrode and the second electrode, e.g., between the negative electrode and the positive electrode. Electrochemical cells can be combined to make a stack in any suitable combination of parallel and series configurations. In an aspect, the electrochemical cell can comprise more than one separator. For example, one of skill in the art would understand that depending on the selected combination of series and parallel configurations, a single separator may be used, or a plurality of separators may be preferred.

The separator can be a porous separator. The porous separator can comprise any suitable material. In an aspect, the porous separator can comprise a polymer film, for example a film comprising a polyamide, a polyolefin, a polyaramid, a polyester, a polyurethane, an acrylic resin, or a combination thereof. The polymer may be coated on one or both sides with a ceramic nanoparticle. In an aspect, the porous separator can comprise cellulose, a synthetic polymeric material, or a polymer/ceramic composite material. Further examples of separators can include polyvinylidene difluoride (PVDF) separators, polytetrafluoroethylene (PTFE), PVDF-alumina composite separators, or a microporous olefin, such as a microporous polyethylene or microporous polypropylene.

The electrochemical cell can further comprise a current collector which conducts electrons from the electrode to the adjacent cell (in series-stacked configurations) or from the electrode to a terminal connection (in parallel-stacked configurations). The current collector can comprise, for example, carbon, a metal, or a combination thereof. In an aspect, the current collector can comprise carbon. Suitable examples of the carbon can include, but are not limited to, graphite, flaked graphite, expanded graphite, carbon fiber, carbon nanotubes, amorphous carbon, graphene, or a combination thereof. The carbon nanotubes may comprise single-wall carbon nanotubes or multi-wall carbon nanotubes. Carbon nanotubes are primarily carbon, although the nanotube fiber may further comprise other atoms, such as boron, nitrogen, or one or more of various metals. In an aspect, the current collector can comprise a metal. The metal can comprise Fe, Zn, Ti, Cu, Al, Ni, Mg, Sn, Cr, Mn, Au, Mo, W, In, V, Nb, Ag, an alloy or intermetallic thereof, or a combination thereof. In an aspect the alloy is a stainless steel, such as 304 or 316 stainless steel.

In an aspect, the carbon or metal may have a spherical, flake, or fibrous morphology. In an aspect, the metal may be in the form of a metal mesh, foam, felt, or an expanded metal. The carbon or metal particles can be oriented. For example, when the metal is in the form of a fiber, the fibers can be oriented such that a long axis is oriented in a direction perpendicular to a major surface of the current collector, e.g., such that the fiber is oriented orthogonal to the surface, e.g., in a through-plane direction.

In an aspect, the current collector can comprise a composite comprising the carbon, the metal, and a binder. The carbon or metal in the composite can be present in an amount of 10 to 98 vol %, based on the total volume of the composite. In an aspect, the composite comprises the carbon or the metal in an amount of 50 to 95 vol %, based on the total volume of the composite. In an aspect, the composite comprises carbon nanotubes or graphene and can include the carbon nanotubes or graphene in an amount of 10 to 40 vol %, based on the total volume of the composite. The composite may comprise a pore, and the pore may contain a polymer.

The binder, when present, can comprise a polymer. The binder can be a thermoset or a thermoplastic. Suitable polymer binders can include, for example, an epoxy, a phenolic, a vinyl ester, a polyarylene sulfide, a polybenzoxazine, an isocyanate, a fluoropolymer, a rubber, or a combination thereof. Representative polymer binders can include polyacrylic acid (PAA), polyvinylidene difluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene-rubber, or a fluorinated rubber. A combination comprising one of the foregoing polymer binders may be used.

The binder can optionally further include an additive. Specific additives can include flow promoters, mold release agents, or a combination thereof. In an aspect, the polymer binder can be crosslinked. The polymer can be an electrical insulator or an electrical conductor. An exemplary electrically conducting polymer can be found, for example, in U.S. Publication No. 2004/977797, the contents of which are incorporated by reference herein in their entirety for all purposes. Optionally, a conductive material such as carbon black, nanotubes, carbon fiber, graphene, and the like can be embedded in the polymer binder at a surface of the current collector, which, without wishing to be bound by theory, is believed to reduce the contact resistance to an adjacent cell component such as to the gas diffusion layer.

In an aspect, the current collector can optionally comprise a coating disposed on at least a portion of a surface of the current collector. The coating can, without wishing to be bound by theory, serve to reduce corrosion, block ion or gas permeation, or improve electrical contact to the gas-diffusion layer or electrode. The coating, when present, can comprise carbon, a metal, an alloy, or an intermetallic material, or a combination thereof, wherein the metal, alloy, or intermetallic material comprises Ni, Zn, Ti, Sn, Au, V, Mo, Cr, or a combination thereof. The coating can comprise an oxide, boride, nitride, or carbide of a metal, alloy, or intermetallic. Non-limiting examples of coating compositions can include tin oxide, titanium carbide, tungsten carbide, zirconium carbide, indium tin oxide, indium zinc oxide, titanium boride, zirconium boride, titanium niobium oxide, titanium tantalum oxide, lanthanum strontium chromium oxide, lanthanum strontium cobalt oxide, titanium nitride, chromium nitride, vanadium nitride, or a combination thereof. For example, in an aspect, the current collector can be plated with a metal, such as Fe, Ni, or Au, or a corrosion-resistant material such as TiN. In an aspect, the coating can comprise a polymer. An example of a polymer coating is described, for example, in U.S. Publication No. 2007/0298267, the contents of which are incorporated by reference herein in their entirety for all purposes. In an aspect, the coating can comprise an electrically conducting polymer. In an aspect, the coating can comprise the binder as described above, and particles of a conductive material, such as carbon black, carbon nanotubes, graphene, gold, silver, or a combination thereof. In an aspect, the coating comprises vapor-deposited diamond-like carbon, or a product of pyrolysis of a carbonaceous polymer.

The current collector may have any suitable porosity, and in an aspect is nonporous. In an aspect, the current collector is effectively impervious to a target gas, e.g., carbon dioxide.

The electrochemical cell may be stacked in series, and the current collector may block transport of ions and of reactant and released gas from a first cell to a second neighboring cell. Furthermore, the current collector can impart mechanical structure and stability to an electrochemical cell. The current collector can optionally comprise ribs which form channels which provide a flowfield for distribution of the gas across the cell. The rib may conduct electrons across the electrochemical cell and optionally provide desirable structural integrity. The rib, when present, can comprise, for example, carbon, a metal, a composite, or a combination thereof, as disclosed above, and can optionally include the coating, each of which is further described above. The rib may comprise the same material as the current collector. The rib may comprise a different material from the current collector. The rib may comprise a material which can be partially compressed, in order to accommodate manufacturing thickness tolerances. For example, the rib may comprise an electronically-conductive closed-cell foam or gasket. The ribs may be convex or concave portions relative to the surface of the current collector and can have any suitable cross-sectional shape, for example a rectangular or rounded shape.

In an aspect, a first side of the current collector can face an adsorbent electrode (e.g., the first electrode), and a second, opposite side of the current collector faces a non-adsorbent counter electrode (e.g., the second electrode) or an end plate. In an aspect, both sides of the current collector can face adsorbent electrodes. The side of the current collector which faces an adsorbent electrode may comprise a flow field. The sides of the current collector, e.g., the first side and the second side, can each independently comprise the same or a different material. In an aspect, an intervening layer comprising a barrier material, such as a material which is electrically conductive and can block the transport of ions or gas, can be interposed between the first and second sides of the current collector. In an aspect, the barrier material can comprise a metal foil.

The current collector can include a feature to aid with sealing the perimeter of the apparatus. Such features can include grooves, steps, bevels, or a combination thereof. Such features are described, for example, in U.S. Publication No. 2002/0197519, the contents of which are incorporated by reference herein in their entirety for all purposes.

The current collector can further comprise a channel extending through the interior of the current collector, preferably through which coolant can flow. The coolant channel can be arranged so that the coolant flow rate is highest in the region of the cell expected to have the highest rate of heat generation, as can be readily determined by one of ordinary skill in the art. Use of a parallel or serpentine configuration is mentioned. In an aspect in which a foam or mesh, such as an electrically conductive foam or mesh, is used, the coolant can flow through the foam or mesh. The foam or mesh may be provided between two layers of the current collector. In an aspect, the coolant can flow through a corrugated or waveform structure, provided between opposite layers of the current collector.

In an aspect, the current collector can comprise a first sheet that contains a channel for reactant gas flow on a first face, and a channel for coolant on a second, opposite face. The first sheet can be attached to a second sheet, which forms a boundary for the coolant channels while providing electrical conduction orthogonal to the face of the sheets. The first sheet can be attached to the second sheet by any suitable method, for example, brazing, welding, soldering, laminating, diffusion bonding, compression, or adhesive bonding. The coolant channels can be formed by nesting adjacent plates, which contain flow-fields for the first and second electrodes. Coolant channels are described in U.S. Pat. No. 6,099,984, and further exemplary coolant flow patterns can be found in provided in U.S. Publication Nos. 2004/0209150 and 2003/0203260, the contents of each of which are incorporated by reference herein in their entirety for all purposes.

The current collector can further comprise a sensor, e.g., a voltage sensor or a voltage sensing wire connected to the current collector. In an aspect, the current collector can further comprise a heating element.

In an aspect, the current collector can comprise members to facilitate assembly, such as alignment pins. Alternatively, a frame may be provided at a periphery of the current collector to aid alignment or sealing. Examples of various suitable current collector components can be found in U.S. Publication No. 2003/0022052, the contents of which are incorporated by reference herein in their entirety for all purposes

The electrochemical cell can optionally further comprise a gas flow field. The gas flow field, when present, can be positioned between the first electrode and the current collector. When the gas diffusion layer is not present in the electrochemical cell, the gas flow field can be positioned adjacent to the first electrode, on a side opposite the separator. In an aspect, the gas flow field can be positioned adjacent to a current collector or a side of the current collector may comprise a flow field. The flow field can comprise structures for directing the reacting fluid to flow from a flow inlet to a flow outlet. Without wishing to be bound by theory, the flow field serves to provide uniform reactant flow to the electrode area. Preferably, the flow field provides uniform reactant flow to the electrode area, a low barrier to flow e.g., a low pressure drop, and suitable electrical conduction from the electrode through the flow field to the current collector.

The gas flow field can optionally further comprise a gas diffusion layer. The gas diffusion layer can be positioned adjacent to the first electrode, on a side opposite the separator. The gas diffusion layer can comprise a porous, electrically conductive material. In an aspect, the gas diffusion layer has a porosity, for example, of greater than or equal to 60%, greater than or equal to 70%, greater than or equal to the 75%, greater than or equal to 80%, or greater. In an aspect, the gas diffusion layer has a porosity of less than or equal to 85%, less than or equal to 90%, or more. Combinations of these ranges are possible. For example, in an aspect, the gas diffusion layer of the first electrode has a porosity of greater than or equal to 60% and less than or equal to 90%. Other porosities are also possible. Examples of suitable materials for the gas diffusion layer include, without limitation, carbon paper (treated, PTFE-treated, or untreated), carbon cloth, or a nonwoven carbon fiber or carbon nanotube mat.

In an aspect, the flow field can comprise a porous foam or mesh. The foam or mesh can be bonded to a nonporous plate by a conductive adhesive, welding, heat-bonding, or sintering.

The flow field can comprise a channel. The channel can be defined by two or more ribs. In an aspect, the channels, the ribs, or both can each independently have average widths of at least 0.1 mm, at least 0.2 mm, at least 0.3 mm, at least 0.4 mm, at least 0.5 mm, at least 0.6 mm, at least 0.8 mm, at least 0.9 mm, at least 1 mm, at least 2 mm, at least 3 mm, at least 4 mm, at least 5 mm, at least 6 mm, at least 7 mm, at least 8 mm, or at least 9 mm. In an aspect, the channels, the ribs, or both can each independently have average widths of no more than 10 mm, no more than 9 mm, no more than 8 mm, no more than 7 mm, no more than 6 mm, no more than 5 mm, no more than 4 mm, no more than 3 mm, no more than 2 mm, no more than 1 mm, no more than 0.9 mm, no more than 0.8 mm, no more than 0.7 mm, no more than 0.6 mm, no more than 0.5 mm, no more than 0.4 mm, no more than 0.3 mm, or no more than 0.2 mm. Combinations of the above-referenced average widths for the channels and/or the ribs are also possible.

In an aspect, the channels, the ribs, or both can each independently have average depths of at least 0.1 mm, at least 0.2 mm, at least 0.3 mm, at least 0.4 mm, at least 0.5 mm, at least 0.6 mm, at least 0.8 mm, at least 0.9 mm, at least 1 mm, at least 2 mm, or at least 3 mm. In an aspect, the channels, the ribs, or both can each independently have average depths of no more than 4 mm, no more than 3 mm, no more than 2 mm, no more than 1 mm, no more than 0.9 mm, no more than 0.8 mm, no more than 0.7 mm, no more than 0.6 mm, no more than 0.5 mm, no more than 0.4 mm, no more than 0.3 mm, or no more than 0.2 mm. Combinations of the above-referenced average depths for the channels and/or the ribs are also possible.

Various methods for manufacturing a flow field may be used, e.g., machining, injection molding, compression molding, extruding, embossing, or stamping. Exemplary methods are described, for example, in U.S. Publication No. 2004/0151975 and U.S. Publication No. 2003/0022052, the contents of each of which are incorporated by reference herein in their entirety for all purposes. In an aspect, the flow field can comprise a corrugated metal with couplings to route the flow from one channel to a neighboring channel, for example as described in U.S. Publication No. 2002/0081477, the contents of which are incorporated by reference herein in their entirety for all purposes.

A flow pattern of the flow field can have any suitable configuration, e.g., to provide parallel, serpentine, or interdigitated flow. Non-limiting examples of serpentine flow patterns are provided in U.S. Pat. No. 6,309,773, the contents of which are incorporated by reference herein in their entirety for all purposes. Flow channels can have a uniform cross-section or can have regions which are tapered or constricted, e.g., to provide a suitable distribution of reactant across the cell area. The flow channels may contain a disruption or obstacle, e.g., to generate turbulence which can improve transport of reactants into the electrode. Exemplary flow channels are described in U.S. Pat. No. 6,756,149, the contents of which are incorporated by reference herein in their entirety for all purposes. The flow field pattern and dimensions can be the same for each flow field in a cell, or they can vary depending on the position of the cell within the stack and the nature of the electrode facing the flow field, as can be readily determined by a skilled person. In an aspect, when channels on both faces of the current collector are present, the channels can be nested to reduce the thickness of the stack.

In an aspect, a manifold can be used to deliver a process gas, e.g., a reactant gas, to the electro-swing adsorption cell, and to convey a product gas, e.g., a released gas, away from the electro-swing adsorption cell. The manifold can distribute the gas. Parameters such as manifold length and cross-sectional dimensions can be selected to provide suitable properties, such as pressure drop. The manifold can also preferably prevent leakage of the gas. Exemplary manifold designs that can be used include but are not limited to those disclosed in U.S. Pat. Nos. 6,159,629; 6,174,616; 5,486,430; 5,776,625; and 6,017,648; the contents of each which are incorporated by reference herein in their entirety for all purposes.

In an aspect, the electrochemical cell can include a seal to prevent leakage of process gases out of the electro-swing adsorption cell. The surface facing the seal region, e.g., a surface of the gas-diffusion layers, electrodes, or separators, can be impregnated at their periphery with a gas-impermeable sealant. Preferably, the geometry of the seal is selected such that stress that can result in puncture, fatigue, or tearing of the separator is not introduced. The thickness of the seal can be uniform or can vary across different regions of the seal with respect to the edge of the electrode and the gas diffusion layer. The seal is electrically insulating and chemically and electrochemically unreactive. The seal can comprise a suitable o-ring, gasket, or adhesive. The seal can comprise a ridge or bead of fluid-impermeable material deposited on the periphery of a member, such as the current collector or manifold. In an aspect, the seal can comprise an elastomer, and can be a thermoset or a thermoplastic, for example, an epoxy, a rubber, a polyolefin, a silicone, a fluoropolymer, a fluoro-elastomer, or a chloropolymer. In an aspect, the seal can comprise a foam, for example a foamed rubber. In an aspect, the seal can comprise a heat-shrinkable film. Exemplary seal materials are described in U.S. Pat. No. 6,440,597 and U.S. Publication No. 2006/0073385, the contents of each of which are incorporated by reference herein in their entirety for all purposes.

In an aspect, when the seal is a gasket, the gasket can optionally comprise a filler, which preferably can provide a coefficient of thermal expansion of the gasket material that is matched to that of the adjacent material, e.g., the current collector material. Exemplary fillers can include, but are not limited to, glass, polystyrene, poly(tetrafluoroethylene) (PTFE), or an insulating metal oxide such as silica or alumina.

Suitable seals can be manufactured by any suitable method, e.g., injecting a bonding polymer into a groove around the edge of the cell, for example as described in U.S. Publication No. 2003/0031914, the contents of which are incorporated by reference herein in their entirety for all purposes. The method can comprise forming grooved surfaces with correspondingly shaped gaskets, for example as described in U.S. Publication No. 2003/0072988, the contents of which are incorporated by reference herein in their entirety for all purposes. In an aspect, the sealant material can be coated, sprayed, laminated, or injection molded onto the current collector or onto an assembly of the gas diffusion layer, electrodes, separator, or a combination thereof. The sealant can encapsulate the exterior-facing edges of the cell. Examples of seal geometries are described in U.S. Publication Nos. 2007/0231619, 2007/0042254, and 2002/0172852, and U.S. Pat. No. 6,261,711, the contents of each of which are incorporated by reference herein in their entirety for all purposes. In an aspect, a gasket on opposite sides of the separator can be connected to each other through through-holes optionally included in a peripheral region of the separator.

To improve sealing, in an aspect the separator can be nonporous in the periphery region. A method of rendering the separator nonporous comprises hot-pressing the separator at a temperature sufficient to cause the material (e.g., a polymeric material) of the separator to flow, thereby filling the pores. The separator can be hot-pressed or thermally bonded to a gasket, or adhered with a sealant.

It can be advantageous to remove heat from the electrochemical cell to prevent the internal temperature from exceeding temperatures that can damage the electrochemical cell. Heat removal can be achieved through the use of coolant channels, discussed previously. In an aspect, the electrochemical cell can be cooled by blowing air over a side of the electrochemical cell. In an aspect, the electrochemical cell can be cooled by flowing coolant through tubes or ducts alongside a side or within the electrochemical cell. In an aspect, the current collector can be devoid of any coolant channels, and cooling can be provided by controlling the flow rate of a process gas through the electrochemical cell, effectively using the process gas as a coolant. This cooling method can be particularly advantageous if the process gas (reactant gas) is air.

In an aspect, at least a portion of the electrochemical cell can be heated. For example, an end portion of the electrochemical cell can be heated, or the cells at the ends of the electrochemical cell (e.g., the “end cells”) can be heated. Without wishing to be bound by theory, heating the electrochemical cell can enable higher capture rate or prevent water condensation from a humid process gas. Electrical-resistance heating elements can be incorporated or disposed adjacent to an end plate or a manifold, for example.

Applying pressure across an electrochemical cell can be advantageous to reduce contact resistance between components within the electrochemical cell e.g., contact resistance between the flow field and the gas diffusion layer. Application of pressure can also be advantageous to improve seal hermeticity. Pressure can be applied across an electrochemical cell, for example, using tie rods or external clamps. A tie rod can be internal or external to the seals and manifolds. It can be preferable to apply pressure uniformly, without localized regions of mechanical stress that can lead to mechanical failure. Those skilled in the art will be familiar with the design of washers, disc springs, coiled springs, belleville washers, nuts, clamps, frames, fasteners, collets, wedges, or pressure plates to apply uniform pressure and avoid stress concentration. Examples of compression assemblies are described in, for example, U.S. Pat. No. 6,190,793, the contents of which are incorporated by reference herein in their entirety for all purposes

The polyquinone of the present disclosure can be reactive towards a target gas. The target gas is an electrophilic molecule. In an aspect, the target gas is a Lewis acid gas or a Bronsted acid gas, preferably a Lewis acid gas. The target gas is capable of forming a complex or an adduct with the polyquinone when the polyquinone is in a reduced state, for example, by bonding to the polyquinone in its reduced state. The target gas can comprise carbon dioxide (CO₂), a sulfur oxide species such as sulfur dioxide (SO₂) or sulfur trioxide (SO₃), an organosulfate (R₂SO₄, where each R is independently hydrogen, C₁₋₁₂ alkyl, or C₆₋₂₀ aryl) such as dimethyl sulfate, a nitrogen oxide species such as nitrogen dioxide (NO₂) or nitrogen trioxide (NO₃), a phosphate ester (R₃PO₄, where each R is independently hydrogen, C₁₋₁₂ alkyl, or C₆₋₂₀ aryl) such as trimethyl phosphate, an ester (RCOOR′ where each R is independently hydrogen, C₁₋₁₂ alkyl, or C₆₋₂₀ aryl, and each R′ is independently C₁₋₁₂ alkyl or C₆₋₂₀ aryl) such as methyl formate or methyl acrylate, an aldehyde (RCHO, where each R is independently hydrogen, C₁₋₁₂ alkyl, or C₆₋₂₀ aryl) such as formaldehyde or acrolein, a ketone (R₂CO, where each R is independently hydrogen, C₁₋₁₂ alkyl, or C₆₋₂₀ aryl) such as acetone, an isocyanate (RNCO, where each R is independently hydrogen, C₁₋₁₂ alkyl, or C₆₋₂₀ aryl, and each R′ is independently C₁₋₁₂ alkyl or C₆₋₂₀ aryl) such as methyl isocyanate, isothiocyanate (RNCS, where each R is independently hydrogen, C₁₋₁₂ alkyl, or C₆₋₂₀ aryl, and each R′ is independently C₁₋₁₂ alkyl or C₆₋₂₀ aryl), a borane (BR₃, where each R is independently hydrogen, C₁₋₁₂ alkyl, or C₆₋₂₀ aryl) such as trimethyl borane, or a borate (R₃BO₃, where each R is independently hydrogen, C₁₋₁₂ alkyl, or C₆₋₂₀ aryl) such as trimethyl borate. The target gas can optionally comprise a combination of any of the foregoing target gas species.

In an aspect, the polyquinone in a reduced state can have a binding constant with a target gas (e.g., carbon dioxide) of at least 10¹ M⁻¹, preferably 10¹ to 10²⁰ M⁻¹, more preferably 10³ to 10²⁰. In an aspect, a binding constant with a target gas may be 10³ to 10²⁰ M⁻¹, 10⁵ to 10¹⁸ M⁻¹, or 10⁸ to 10⁵ M⁻¹.

As such, an electrochemical cell comprising the polyquinone can be particularly useful for the separation of a target gas from a gas mixture when the gas mixture is contacted with the electrochemical cell, and thus is particularly well suited for use in a gas separation system. The gas separation system can comprise a plurality of electrochemical cells in fluid communication with a gas inlet and a gas outlet. In an aspect, the gas separation system can further comprise a contactor unit in fluid contact with a gas mixture. In an aspect, the contactor unit can be in fluid communication with an electrolyte. The contactor unit can include, for example, a gas adsorber, a gas absorber, or a combination thereof.

The gas mixture, also referred to as the input gas, can be at least partially separated upon exposure to the electrochemical cell. The gas mixture can be, for example, ambient air (e.g., air from an ambient environment, such as outdoor air). In an aspect, the gas separation system can be used for direct air capture. The systems and methods described herein can be useful for removing a target gas such as carbon dioxide directly from ambient air (e.g., to reduce greenhouse gas levels), without the need for any pre-concentration step. Certain aspects of the present disclosure can make the systems and methods described herein particularly useful for direct air capture (e.g., an ability to bond with a target gas while being thermodynamically disfavored from reacting with major components of ambient air, such as oxygen).

In an aspect, the concentration of the target gas in the gas mixture is relatively low, for example when the gas mixture is ambient air. For example, the concentration of the target gas in the gas mixture prior to exposure to the electrochemical cell can be less than or equal to 500 ppm, or less than or equal to 450 ppm, or less than or equal to 400 ppm, or less than or equal to 350 ppm, or less than or equal to 300 ppm, or less than or equal to 200 ppm. In an aspect, the concentration of the target gas in the gas mixture can be as low as 100 ppm, or as low as 50 ppm, or as low as 10 ppm.

In an aspect, the gas mixture (e.g., input gas mixture) is ventilated air. The ventilated air can be air in an enclosed or at least partially enclosed place (e.g., air being circulated in an enclosed place). Examples of places in which the gas mixture (e.g., ventilated air) can be located include, but are not limited to sealed buildings, partially ventilated places, car cabins, inhabited submersibles, air crafts, and the like.

The concentration of target gas in the ventilated air can be higher than ambient air but lower than concentrations typical for industrial processes. In an aspect, the concentration of the target gas in the gas mixture prior to exposure to the electrochemical cell is less than or equal to 5,000 ppm, or less than or equal to 4,000 ppm, or less than or equal to 2,000 ppm, or less than or equal to 1,000 ppm. In an aspect, the concentration of the target gas in the gas mixture (e.g., when it is ventilated air/air in enclosed spaces) is as low as 1,000 ppm, or as low as 800 ppm, or as low as 500 ppm, or as low as 200 ppm, or as low as 100 ppm, or as low as 10 ppm.

In an aspect, the gas mixture comprises oxygen gas (02). In an aspect, the gas mixture has a relatively high concentration of oxygen gas (e.g., prior to exposure to the electrochemical cell). Certain aspects of the systems and methods described herein (e.g., the choice of particular electroactive species, methods of handling gases in the system, etc.) can contribute to an ability to capture target gases in gas mixtures in which oxygen gas is present without deleterious interference. In an aspect, oxygen gas is present in the gas mixture (e.g., prior to exposure to the electrochemical cell) at a concentration of greater than or equal to 0 volume percent, or greater than or equal to 0.1 volume percent, or greater than or equal to 1 volume percent, or greater than or equal to 2 volume percent, or greater than or equal to 5 volume percent, or greater than or equal to 10 volume percent, or greater than or equal to 20 volume percent, or greater than or equal to 50 volume percent, or greater than or equal to 75 volume percent, or greater than or equal to 90 volume percent, greater than or equal to 95 volume percent. In an aspect, oxygen gas is present in the gas mixture at a concentration of less than or equal to 99 volume percent, or less than or equal to 95 volume percent, or less than or equal to 90 volume percent, or less than or equal to 75 volume percent, or less than or equal to 50 volume percent, or less than or equal to 25 volume percent, or less than or equal to 21 volume percent, or less than or equal to 10 volume percent, or less than or equal to 5 volume percent, or less than or equal to 2 volume percent.

In an aspect, the gas mixture comprises water vapor. The gas mixture can comprise water vapor for example, because it is or comprises ambient air or ventilated air. In an aspect, the gas mixture (e.g., prior to exposure to the electrochemical cell) has a relatively high relative humidity. For example, in an aspect, the gas mixture can have a relative humidity of greater than or equal to 0%, or greater than or equal to 5%, or greater than or equal to 10%, or greater than or equal to 25%, or greater than or equal to 50%, or greater than or equal to 75%, or greater than or equal to 90% at at least one temperature in the range of −50 to 140° C. In an aspect, the gas mixture can have a relative humidity of less than or equal to 100%, or less than or equal to 95%, or less than or equal to 90%, or less than or equal to 75%, or less than or equal to 50%, or less than or equal to 25%, or less than or equal to 10% at at least one temperature in the range of −50 to 140° C.

The target gas can be separated from the gas mixture in the gas separation system by applying a potential difference across the electrochemical cells of the gas separation system. One of ordinary skill, with the benefit of this disclosure, would understand how to apply a potential across the electrochemical cell. For example, the potential can be applied by connecting the negative electrode and the positive electrode to a suitable power source capable of polarizing the negative and positive electrodes. In an aspect the power supply can be a DC voltage. Nonlimiting examples of a suitable power source include batteries, power grids, regenerative power supplies (e.g., wind power generators, photovoltaic cells, tidal energy generators), generators, and the like, and combinations thereof.

The potential difference can be applied to the electrochemical cells during at least a portion of the time that a gas mixture is exposed to the electrochemical cell. In an aspect, the potential difference can be applied prior to exposing the gas mixture to the electrochemical cell.

Application of a positive voltage to the electrochemical cell, during a charging mode, results in a redox reaction at the negative electrode wherein the polyquinone is reduced. As discussed herein, the polyquinone is selected for having a higher affinity for the target gas when it is in a reduced state relative to when it is in an oxidized state. By reducing the polyquinone and passing a gas mixture across the first electrode, the target gas can bond to the polyquinone. In this way the target gas can be removed from the gas mixture to provide a treated gas mixture (e.g., comprising a lesser amount of the target gas relative to the initial gas mixture).

The potential difference applied across the electrochemical cell, during the charge mode, can have a particular voltage. The potential difference applied across the electrochemical cell can depend, for example, on the reduction potential for the generation of at least one reduced state of the first electroactive species, as well as the standard potential for the interconversion between a reduced state and an oxidized state of the polyquinone in the second electrode. The voltage further includes the current multiplied by the stack electrochemical resistance. In an aspect, the potential difference is at least 0 V, or at least 0.1 V, or at least 0.2 V, or at least 0.5 V, or at least 0.8 V, or at least 1.0 V, or at least 1.5 V. In an aspect, the potential difference is less than or equal to 2.0 V, or less than or equal to 1.5 V, or less than or equal to 0.5 V, or less than or equal to 0.2 V.

In an aspect, for example when the polyquinone is according to Formula (I), the polyquinone can be reduced to at least one of its reduced states, for example, as shown below:

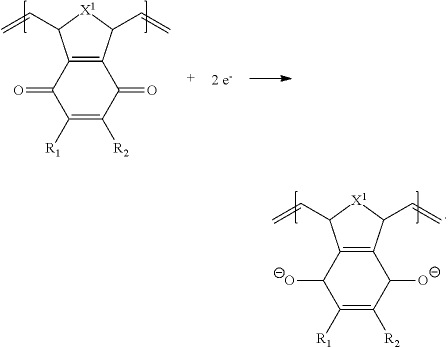

In an aspect, when the polyquinone is reduced in the presence of a target gas, for example carbon dioxide, the reduced form of the polyquinone can bond with the carbon dioxide:

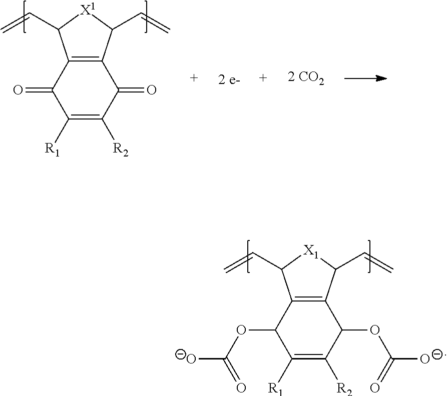

In an aspect, while the polyquinone is reduced at the first electrode, an electroactive species (e.g., a redox active polymer such as polyvinyl ferrocene) is being oxidized at the second electrode. During the charge mode, the oxidation of the electroactive species provides a source of electrons for driving the reduction of the polyquinone.

While the exemplary reaction shown above is shown taking place in one direction, it will be understood that some reversibility can be exhibited. Analogous reaction can take place with different electroactive species, as would be understood by a person of ordinary skill in the art.

In an aspect, a relatively large amount of the target gas is removed from the gas mixture during the processes described herein. Removing a relatively large amount of the target gas can, in some cases, be beneficial for any of a variety of applications, such as capturing gases that can be deleterious if released into the atmosphere for environmental reasons. For example, the target gas can comprise carbon dioxide, and removing a relatively high amount of the carbon dioxide from gas mixture can be beneficial to either limit the greenhouse gas impact of a process (e.g., an industrial process or transportation process) or to even reduce the amount of carbon dioxide in a room or the atmosphere (either for thermodynamic reasons for heating and air conditioning processes or for environmental reasons).

In an aspect the amount of target gas in a treated gas mixture (e.g., a gas mixture from which an amount of the target gas is removed upon being exposed to the electrochemical cell) is less than or equal to 50%, less than or equal to 25%, less than or equal to 10%, less than or equal to 5%, less than or equal to 2%, less than or equal to 1%, less than or equal to 0.5%, less than or equal to 0.1% of the amount (in volume percent) of the target gas in the original gas mixture prior to treatment (e.g., the amount of the target in the gas mixture prior to being exposed to electrochemical cell). In an aspect, the amount of target gas in a treated gas mixture is greater than or equal to 0.001%, greater than 0.005%, greater than or equal to 0.01%, greater than or equal to 0.05%, greater than or equal to 0.1%, greater than or equal to 0.5%, greater than or equal to 1%, greater than or equal to 2%, greater than or equal to 5% of the amount (in volume percent) of the target gas in the original gas mixture prior to treatment.

In an aspect, a second potential difference can be applied across the electrochemical cell after at least a portion of the target gas is bonded to the polyquinone. The second potential difference can be different than that first potential difference. In an aspect, applying the second potential difference results in a step of releasing a portion or all of the target gas bonded with the polyquinone to produce a second treated gas mixture. The second treated gas mixture can have a greater amount of the target gas than the input gas mixture. For example, target gas may be present in the second treated gas mixture in an amount such that its content is 10 volume percent (vol %), 20 vol %, 50 vol %, 100 vol %, 200 vol %, 1000 vol %, and/or up to 2,000 vol %, 5,000 vol %, 10,000 vol %, or more than the content in the first gas mixture.

The gas separation system can comprise an external circuit connecting the negative electrode and the positive electrode of each electrochemical cell to a power source configured to apply a potential difference across the negatives electrode and the positive electrode of each electrochemical cell. Each of the electrochemical cells of the gas separation system can be as described above. The electrochemical cells of the gas separation system can be stacked according to various configurations that are generally known in the art, including parallel or in series. In an aspect, the quinone-containing polymer can be dissolved in the electrolyte of the electrochemical cell, and the gas mixture can be in fluid contact with the electrolyte comprising the dissolved quinone-containing polymer during operation of the gas separation system. In an aspect, the electrochemical cells of the gas separation system need not be in direct contact with the gas mixture. In an aspect, a gas separation system can further comprise an absorber unit which can be in fluid contact with the gas mixture.

In an aspect, a gas separation system comprises a first set of electrochemical cells and a second set of electrochemical cells. Each of the first set and the second set can comprise one or more electrochemical cells as described throughout this disclosure. The first and second set can be made to run in parallel in an alternating fashion, such that one set of cells is operating in a charge mode and capturing a target gas (e.g., CO₂) from a gas mixture while another set of cells is operating in a discharge mode and releasing the target gas (e.g., CO₂). The system can comprise separate housings for each of the sets of electrochemical cells. The system can further comprise conduits and valving arranged to direct flow in a desired manner. The gas separation system can allow for nearly continuous separation of a gas mixture (e.g., gas stream), with the gas mixture being directed to the set of cells operating in a charge/capture mode, at a given moment, while a separate target gas-rich treated mixture is produced by the other set of cells operating in a discharge/release mode. Furthermore, additional sets of electrochemical cells may be added in parallel or in series, according to the needs of the application.

The gas mixture (e.g., a gas stream such as an input gas stream) can be introduced to the gas separation system at a particular flow rate. In an aspect, the flow rate can be greater than or equal to 0.001 liter per second (L/s), greater than or equal to 0.005 L/s greater than or equal to 0.01, greater than or equal to 0.05 L/s, greater than or equal to 0.1 L/s, greater than or equal to 0.5 L/s, greater than or equal to 1 L/s, greater than or equal to 5 L/s, greater than or equal to 10 L/s, greater than or equal to 10 50 L/s, or greater than or equal to 100 L/s. In an aspect, the flow rate of the gas mixture (e.g., a gas stream such as an input gas stream) can be less than or equal to 500 L/s, less than or equal to 400 L/s, less than or equal to 300 L/s, less than or equal to 200 L/s, less than or equal to 100 L/s, less than or equal to 50 L/s, less than or equal to 10 L/s, less than or equal to 1 L/s, less than or equal to 0.5 L/s, or less than or equal to 0.1 15 L/s. Suitable combinations of the foregoing ranges are mentioned.

In an aspect, during or after the step of releasing the target gas, the method further comprises applying a vacuum condition to the electrochemical cell to remove at least a portion or all of the released target gas from the electrochemical cell. One of ordinary skill, with the benefit of this disclosure, would understand suitable techniques and equipment for applying a vacuum condition to the electrochemical cell. For example, a vacuum pump can be fluidically connected to a gas outlet of the electrochemical cell. The vacuum pump can be operated to produce a negative pressure differential between the electrochemical cell bed and a downstream location. This vacuum condition can provide a force sufficient to cause target gas released during the releasing step described above to flow out of the electrochemical cell. The vacuum condition can be applied such that the pressure inside the electrochemical cell during or after the releasing of the target gas is less than or equal to 760 torr, less than or equal to 700 torr, less than or equal to 500 torr, less than or equal to 100 torr, less than or equal to 50 torr, less than or equal to 10 torr, and/or as low as 5 torr, as low as 1 torr, as low as 0.5 torr, as low as 0.1 torr.

In an aspect, the composite of the first electrode has a particular capacity for absorbing target gas (e.g., CO₂). For example, the composite can have an absorption capacity of at least 0.01 mole per square meter (mol per m²), at least 0.02 mol per m², at least 0.05 mol per m², or more. In an aspect, the composite can have an absorption capacity of less than or equal to 0.2 mol per m², less than or equal to 0.08 mol per m², less than or equal to 0.05 mol per m², less than or equal to 0.03 mol per m², or less. For example, the composite can have an absorption capacity of at least 0.01 mol per m² and less than or equal to 0.2 mol per m², or at least 0.02 mol per m² and less than or equal to 0.08 mol per m².

In an aspect the composite of the first electrode can have a particular surface area that is exposed to the gas mixture, for example, of greater than or equal to 5 cm², greater than or equal to 8 cm², greater than or equal to 10 cm², or up to 10 cm², up to 20 cm² or more.

Various components of a system, such as the electrodes (e.g., negative electrode, positive electrodes), power source, electrolyte, separator, container, circuitry, insulating material, and the like can be fabricated by those of ordinary skill in the art from any of a variety of components. Components can be molded, machined, extruded, pressed, isopressed, printed, infiltrated, coated, in green or fired states, or formed by any other suitable technique.

The electrodes described herein (e.g., negative electrode, positive electrodes) can be of any suitable size or shape. Non-limiting examples of shapes include sheets, cubes, cylinders, hollow tubes, spheres, and the like. The electrodes may be of any suitable size, depending on the application for which they are used (e.g., separating gases from ventilated air, direct air capture, etc.). Additionally, the electrode can comprise a means to connect the electrode to another electrode, a power source, and/or another electrical device. Those of ordinary skill in the art are readily aware of techniques for forming components of system herein.

Various electrical components of system may be in electrical communication with at least one other electrical component by a means for connecting. A means for connecting can be any material that allows the flow of electricity to occur between a first component and a second component. A non-limiting example of a means for connecting two electrical components is a wire comprising a conductive material (e.g., copper, silver, etc.). In an aspect, the system can comprise electrical connectors between two or more components (e.g., a wire and an electrode). In an aspect, a wire, electrical connector, or other means for connecting can be selected such that the resistance of the material is low. In an aspect, the resistances can be substantially less than the resistance of the electrodes, electrolyte, or other components of the system.

Electrochemical cells and gas separation systems of the present disclosure can further be as described in U.S. patent application Ser. No. 16/659,398, the contents of which is incorporated by reference in its entirety for all purposes.

The electrochemical cells, systems, and methods described herein can be implemented in a variety of applications. The number of electrochemical cells or sets of cells can be scaled to the requirements of a particular application as needed. The following aspects provide several non-limiting examples of applications. In an aspect, the systems and methods described herein can be for removing a target gas (e.g., CO₂) from ambient air, as well as enclosed spaces such as airtight building, car cabins—reducing the heating cost of incoming air for ventilation—and submarines and space capsules, where an increase in CO₂ levels could be catastrophic. In aspects directed to the electrical power industry, they can be used for capturing carbon dioxide post-combustion at varying concentrations. In an aspect, the systems and methods are suitable for separate target gases from industrial flue gas or industrial process gas. Also, they can be used for capturing sulfur dioxide and other gases from flue gas. In aspects directed to the oil and gas industry, the disclosed systems and methods can be used for capturing carbon dioxide and other gases from various processes and diverting them for downstream compression or processing. The disclosed systems and methods can be applied to capture carbon dioxide from burning natural gas used to heat the greenhouses in mild and cold climates, then diverting the captured dioxide into the greenhouse for the plants to use in photosynthesis, i.e., to feed the plants.

This disclosure is further illustrated by the following examples, which are non-limiting.

### Examples

### Synthesis of poly(1,4-dihydro-1,4-methano-6,7-dimethylnaphthalene-5,8-dione)

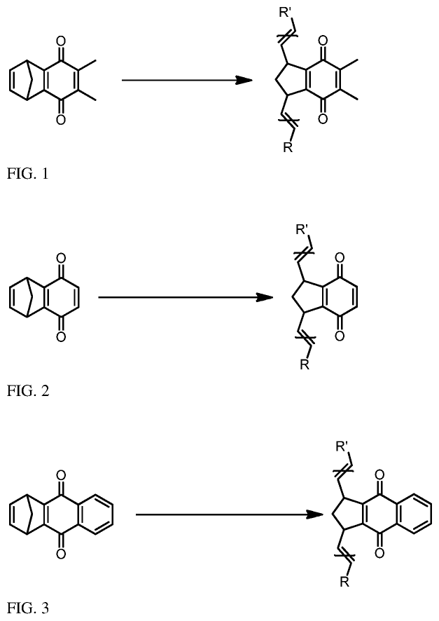

Poly(1,4-dihydro-1,4-methano-6,7-dimethylnaphthalene-5,8-dione) was synthesized according to the scheme shown in FIG. 1.

In a nitrogen glovebox, a 20 mL scintillation vial with stirbar was charged with 1,4-dihydro-1,4-methano-6,7-dimethylnaphthalene-5,8-dione (850 mg, 4.25 mmol) and dry toluene (5 mL). To the resulting bright yellow solution was added the molybdenum alkylidene metathesis catalyst (“Schrock F6”; CAS: 139220-25-0; 33 mg, 43 μmol) as a solid in one portion. The reaction mixture was stirred at room temperature for 1 h, then excess benzaldehyde (500 μL) was added to quench the reaction. The reaction mixture was then stirred for 1 h and removed from the glovebox, then added dropwise to rapidly stirring MeOH (50 mL). The resulting precipitate was collected by filtration and dried to yield the product polymer as a pale yellow-brown solid. ¹H NMR (400 MHz, CDCl₃): δ=5.42 (br, 1H); 5.28 (br, 1H); 4.30 (br, 2H); 2.82 (br, 1H); 1.97 (br, 7H).

### Synthesis of poly(1,4-dihydro-1,4-methanonaphthalene-5,8-dione)

Poly(1,4-dihydro-1,4-methanonaphthalene-5,8-dione) was synthesized according to the scheme shown in FIG. 2.

In a nitrogen glovebox, a 20 mL scintillation vial with stirbar was charged with 1,4-dihydro-1,4-methanonaphthalene-5,8-dione (250 mg, 1.45 mmol) and dry chlorobenzene (4 mL). To the resulting yellow solution was added the molybdenum alkylidene metathesis catalyst (“Schrock F6”; CAS: 139220-25-0; 22 mg, 29 μmol) as a solid in one portion. The reaction mixture was stirred at room temperature for 3 h, then excess benzaldehyde (100 μL) was added to quench the reaction. The reaction mixture was then stirred for 1 h and removed from the glovebox, then added dropwise to rapidly stirring MeOH (50 mL). The resulting precipitate was collected by filtration and dried to yield the product polymer as a gray powder. ¹H NMR (400 MHz, CDCl₃): δ=6.68 (br, 2H); 5.48 (br, 1H); 5.34 (br, 1H); 4.34 (br, 2H), 2.81 (br, 1H), 1.65 (br, 1H).

### Synthesis of poly(1,4-dihydro-1,4-methanoanthracene-9,10-dione)

Poly(1,4-dihydro-1,4-methanoanthracene-9,10-dione) was synthesized according to the scheme shown in FIG. 3.

In a nitrogen glovebox, a 2 dram vial with stirbar was charged with 1,4-dihydro-1,4-methanoanthracene-9,10-dione (125 mg, 0.56 mmol) and dry chlorobenzene (2 mL). To the resulting yellow solution was added the molybdenum alkylidene metathesis catalyst (“Schrock F6”; CAS: 139220-25-0; 8 mg, 10 μmol) as a solid in one portion; a pale solid rapidly forms in the reaction mixture. The reaction mixture was stirred at room temperature overnight (˜16 h), then excess benzaldehyde (100 μL) was added to quench the reaction. The reaction mixture was then stirred for 1 h and removed from the glovebox, then added to MeOH (50 mL). The suspended solid was collected by filtration and dried to yield the product polymer as a pale brown powder. ¹H NMR (400 MHz, CDCl₃): δ=8.04 (br, 2H); 7.67 (br, 2H); 5.60 (br, 1H); 5.39 (br, 1H); 4.55 (br, 2H); 3.09 (br, 1H); 0.83 (br, 1H).

This disclosure further encompasses the following aspects.

Aspect 1: A quinone-containing polymer comprising repeating units of at least one of Formulas (I) to (IV) or a hydrogenated derivative thereof

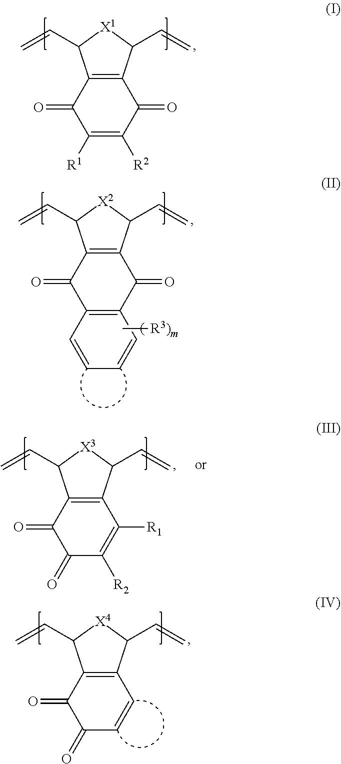

wherein in Formulas (I) to (IV), X¹ is —CH₂— or —O—; X² is —CH₂— or —O—; X³ is —CH₂— or —O—; X⁴ is —CH₂— or —O—; R¹ and R² are independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group; R³ is independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, or a thiol group, an amine group, an amide group, an ester group, or a ketone group; m is 2 to 4; and the dashed lines of Formulas (II) and (IV) indicate the optional presence of one or more additional fused substituted or unsubstituted aryl groups; provided that when X¹ is —CH₂—, at least one of R¹ and R² is not hydrogen.

Aspect 2: The quinone-containing polymer of aspect 1, wherein the quinone-containing polymer is according to Formula (I).

Aspect 3: The quinone-containing polymer of aspect 2, wherein X¹ is —CH₂—, R¹ is hydrogen, and R² is halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group.

Aspect 4: The quinone-containing polymer of aspect 2, wherein X¹ is —CH₂— and at least one of R¹ and R² is a substituted or unsubstituted C₁₋₆ alkyl group.

Aspect 5: The quinone-containing polymer of aspect 4, wherein X¹ is —CH₂— and R¹ and R² are each a substituted or unsubstituted C₁₋₆ alkyl group, preferably R¹ and R² are each a methyl group.

Aspect 6: The quinone-containing polymer of aspect 2, wherein X¹ is —O—.

Aspect 7: The quinone-containing polymer of aspect 6, wherein R¹ and R² are independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group.

Aspect 8: The quinone-containing polymer of aspect 6, wherein R¹ and R² are each hydrogen.

Aspect 9: The quinone-containing polymer of aspect 1, wherein the quinone-containing polymer is according to Formula (II).

Aspect 10: The quinone-containing polymer of aspect 9, wherein X² is —CH₂— or —O—, m is 4, and no additional fused substituted or unsubstituted aryl groups are present.

Aspect 11: The quinone-containing polymer of aspect 10, wherein each occurrence of R³ is a halogen.

Aspect 12: The quinone-containing polymer of aspect 9, wherein X² is —CH₂— or —O—, m is 2, and the polymer comprises repeating units of Formula (V)

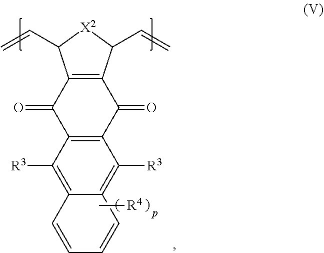

wherein p is 0 to 4 and R⁴ is independently at each occurrence halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group.

Aspect 13: The quinone-containing polymer of any of aspects 1 to 12, wherein the quinone-containing polymer is a copolymer further comprising one or more repeating units different from the repeating units according to any of Formulas (I) to (IV).

Aspect 14: The quinone-containing polymer of aspect 13, further comprising one or more repeating units comprising a crosslinkable group, an adhesion promoting group, a solubilizing group, or a combination thereof.

Aspect 15: The quinone-containing polymer of aspect 13 or 14, wherein the copolymer further comprises repeating units according to one or more of Formulas (IV) to (VI)

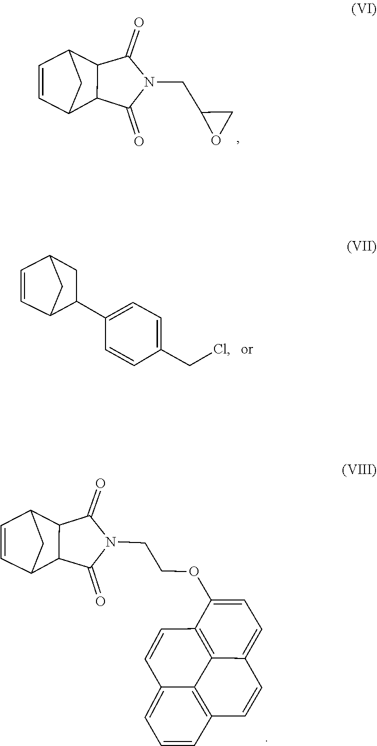

Aspect 16: The quinone-containing polymer of any of aspects 1 to 15, wherein the quinone-containing polymer comprises hydrogenated repeating units of at least one of Formula (Ia) to (IVa)

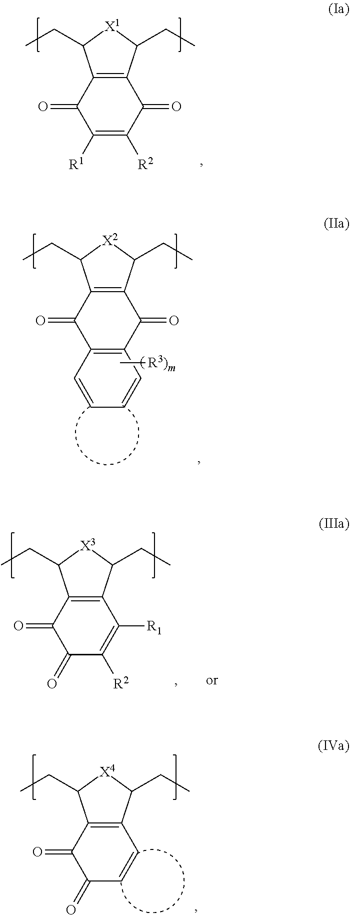

Aspect 17: A method of making a quinone-containing polymer, the method comprising: polymerizing a quinone-containing monomer of at least one of Formula (IX) to (XII)

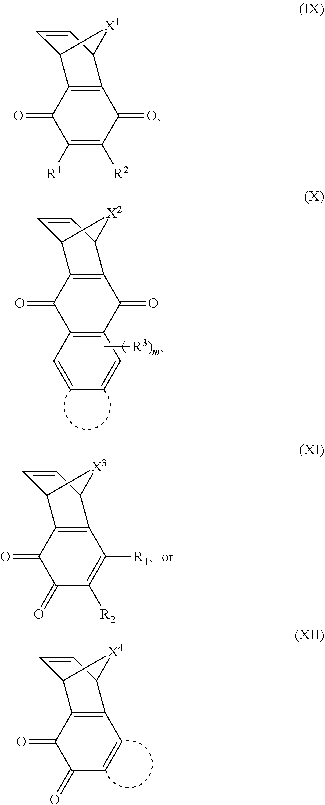

in the presence of a molybdenum alkylidene catalyst or a tungsten alkylidene catalyst under conditions effective to provide a quinone-containing polymer comprising repeating units of at least one of Formulas (I) to (IV) or a hydrogenated derivative thereof

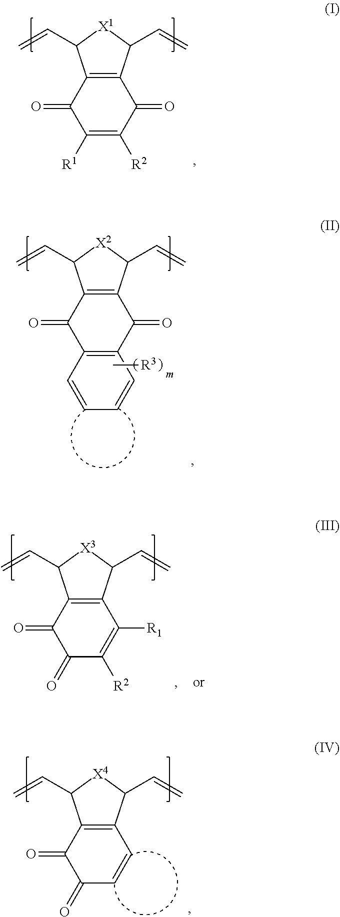

wherein in in the foregoing Formulas, X¹ is —CH₂— or —O—; X² is —CH₂— or —O—; X³ is —CH₂— or —O—; X⁴ is —CH₂— or —O—; R¹ and R² are independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group; R³ is independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group; m is 2 to 4; and the dashed lines of Formula (II), (IV), (XI), and (XII) indicate the optional presence of one or more additional fused substituted or unsubstituted aryl groups.

Aspect 18: The method of aspect 17, wherein the conditions effective to provide the quinone-containing polymer comprise a temperature of 20 to 100° C. and a time of 1 minute to 24 hours, for example 1 to 5 hours, or 2 to 3 hours.

Aspect 19: A composite comprising a quinone-containing polymer disposed on a substrate, wherein the quinone-containing polymer comprises repeating units of at least one of Formula (I) to (IV)

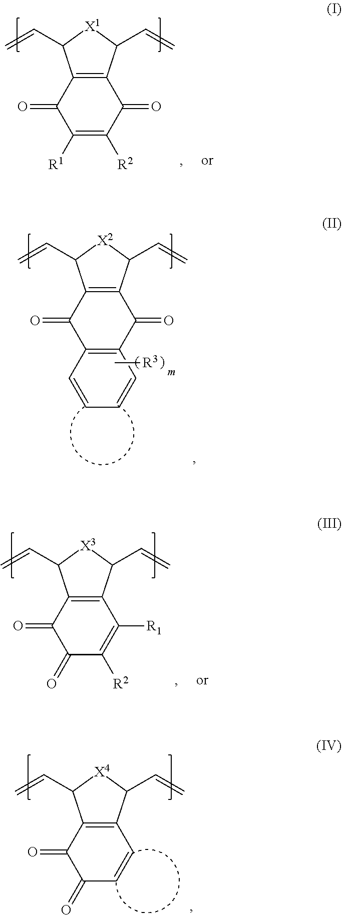

wherein in Formulas (I) to (IV), X¹ is —CH₂— or —O—; X² is —CH₂— or —O—; X³ is —CH₂— or —O—; X⁴ is —CH₂— or —O—; R¹ and R² are independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group; R³ is independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group; m is 2 to 4; and the dashed lines of Formula (II) and (IV) indicate the optional presence of one or more additional fused substituted or unsubstituted aryl groups.

Aspect 20: The composite of aspect 19, wherein the substrate comprises a carbonaceous material.

Aspect 21: The composite of aspect 19 or 20, wherein the quinone-containing polymer is at least partially crosslinked.

Aspect 22: An electrode assembly comprising: a porous separator; and the composite of any of aspects 19 to 21 on a surface of the porous separator, in a pore of the porous separator, or a combination thereof.

Aspect 23: An electrochemical cell comprising the composite of any of aspects 19 to 21.

Aspect 24: The electrochemical cell of aspect 23, comprising: a first electrode comprising the composite of any of aspects 19 to 21; a second electrode comprising a complementary electroactive layer; and a first separator between the first electrode and the second electrode.

Aspect 25: The electrochemical cell of aspect 24, wherein the composite further comprises an electrolyte.

Aspect 26: A gas separation system comprising a plurality of electrochemical cells in fluid communication with a gas inlet and a gas outlet, wherein each of the plurality of electrochemical cells is according to aspect 24 or 25.

Aspect 27: The gas separation system of aspect 26, wherein the gas separation system further comprises contactor unit in fluid contact with a gas mixture.

Aspect 28: The gas separation system of aspect 27, wherein the contactor unit is in fluid communication with an electrolyte.

Aspect 29: An electrochemical cell comprising the quinone-containing polymer of any of aspects 1 to 16.

Aspect 30: The electrochemical cell of aspect 29, comprising: a first electrode; a second electrode; a separator between the first electrode and the second electrode; and an electrolyte contacting at least one of the first electrode or the second electrode, wherein at least one of the first electrode, the second electrode, the separator, or the electrolyte comprises the quinone-containing polymer.

Aspect 31: The electrochemical cell of aspect 30, wherein the electrolyte comprises the quinone-containing polymer.

Aspect 32: A gas separation system comprising: the electrochemical cell according to aspect 31, wherein the electrochemical cell is in fluid communication with a gas inlet and a gas outlet, and the electrolyte comprising the quinone-containing polymer is in fluid contact with a gas mixture.

Aspect 33: The gas separation system of aspect 32, further comprising a contactor unit separate from the electrochemical cell and in which the electrolyte contacts the gas mixture.

Aspect 34: The gas separation system of aspect 33, wherein the contactor unit comprises a gas adsorber, a gas absorber, or a combination thereof.

Aspect 35: The gas separation system of aspect 32, comprising a plurality of the electrochemical cells.

Aspect 36: An energy storage device comprising the quinone-containing polymer of any of aspects 1 to 16, the composite of aspects 19 to 21, or the electrochemical cell of any of aspects 23 to 25.

Aspect 37: An electrochromic device comprising the quinone-containing polymer of any of aspects 1 to 16, the composite of any of aspects 19 to 21, or the electrochemical cell of any of aspects 23 to 25.

Aspect 38: A method for separating a target gas from a fluid mixture comprising the target gas, the method comprising: contacting the fluid mixture with a quinone-containing polymer comprising repeating units according to Formulas (I) to (IV), wherein the quinone-containing polymer is in a reduced state, to form an anion adduct between the target gas and the quinone-containing polymer in the reduced state.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (˜(CH₂)₃—)). “Cycloalkylene” means a divalent cyclic alkylene group, —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A quinone-containing polymer comprising repeating units of at least one of Formula (I) to (IV) or a hydrogenated derivative thereof 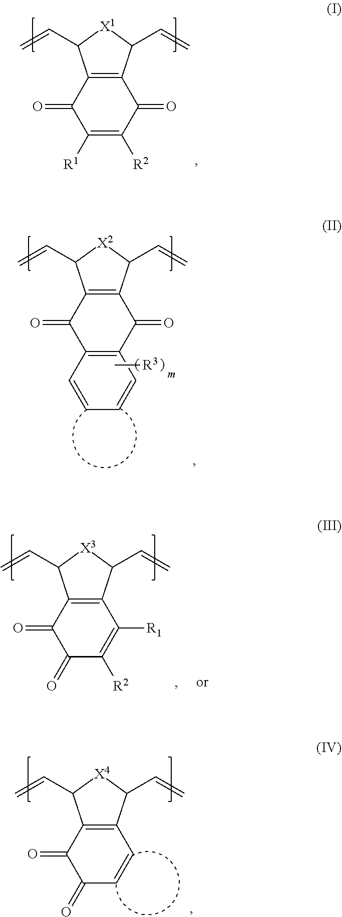
wherein in Formulas (I) to (IV),
X¹ is —CH₂— or —O—;
X² is —CH₂— or —O—;
X³ is —CH₂— or —O—;
X⁴ is —CH₂— or —O—;
R¹ and R² are independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group;
R³ is independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, or a thiol group, an amine group, an amide group, an ester group, or a ketone group;
m is 2 to 4; and
the dashed lines of Formulas (II) and (IV) indicate the optional presence of one or more additional fused substituted or unsubstituted aryl groups;
provided that when X¹ is —CH₂—, at least one of R¹ and R² is not hydrogen.

2. The quinone-containing polymer of claim 1, wherein the quinone-containing polymer is according to Formula (I) and X¹ is —CH₂—, R¹ is hydrogen, and R² is halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group or a ketone group.

3. (canceled)

4. The quinone-containing polymer of claim 2, wherein X¹ is —CH₂— and at least one of R¹ and R² is a substituted or unsubstituted C₁₋₆ alkyl group (or wherein X¹ is —CH₂— and R¹ and R² are each a substituted or unsubstituted C₁₋₆ alkyl group.

5. (canceled)

6. The quinone-containing polymer of claim 2, wherein the quinone-containing polymer is according to Formula (I) wherein X¹ is —O—, and wherein R¹ and R² are independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group.

7. (canceled)

8. (canceled)

9. The quinone-containing polymer of claim 1, wherein the quinone-containing polymer is according to Formula (II).

10. The quinone-containing polymer of claim 9, wherein X² is —CH₂— or —O—, m is 4, and no additional fused substituted or unsubstituted aryl groups are present, optionally wherein each occurrence of R³ is a halogen.

11. (canceled)

12. The quinone-containing polymer of claim 9, wherein X² is —CH₂— or —O—, m is 2, and the polymer comprises repeating units of Formula (V) 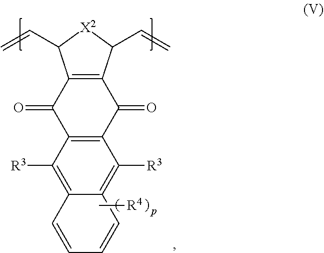
wherein p is 0 to 4 and R⁴ is independently at each occurrence halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group.

13. The quinone-containing polymer of claim 1, wherein the quinone-containing polymer is a copolymer further comprising one or more repeating units different from the repeating units according to any of Formulas (I) to (IV).

14. (canceled)

15. The quinone-containing polymer of claim 13, wherein the copolymer further comprises repeating units according to one or more of Formulas (VI) to (VIII)

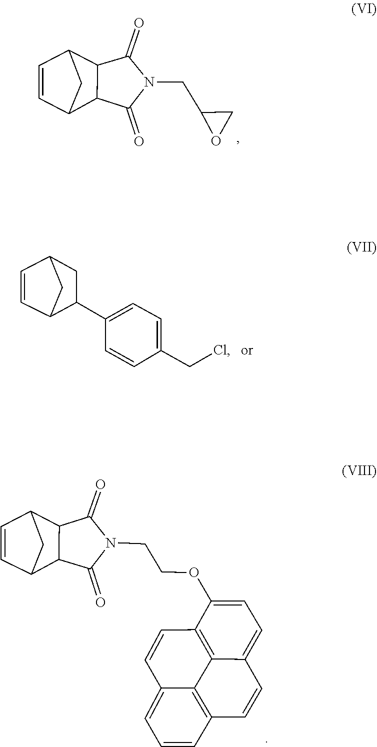

16. The quinone-containing polymer of claim 1, wherein the quinone-containing polymer comprises hydrogenated repeating units of at least one of Formula (Ia) to (IVa)

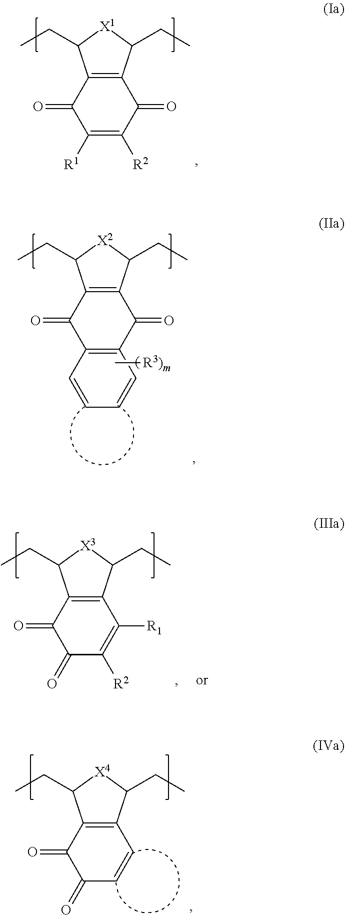

17. A method of making a quinone-containing polymer, the method comprising:
polymerizing a quinone-containing monomer of at least one of Formula (IX) to (XII) 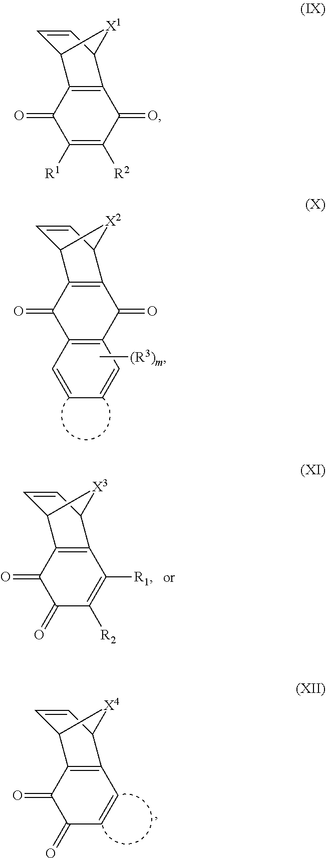
in the presence of an olefin metathesis catalyst under conditions effective to provide a quinone-containing polymer comprising repeating units of at least one of Formula (I) to (IV) or a hydrogenated derivative thereof 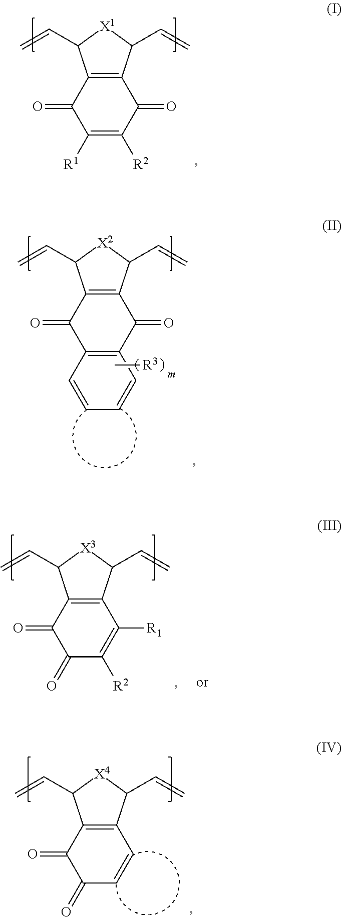
wherein in in the foregoing Formulas,
X¹ is —CH₂— or —O—;
X² is —CH₂— or —O—;
X³ is —CH₂— or —O—;
X⁴ is —CH₂— or —O—;
R¹ and R² are independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group;
R³ is independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group;
m is 2 to 4; and
the dashed lines of Formula (II), (IV), (XI), and (XII) indicate the optional presence of one or more additional fused substituted or unsubstituted aryl groups.

18. (canceled)

19. A composite comprising a quinone-containing polymer disposed on a substrate, wherein the quinone-containing polymer comprises repeating units of at least one of Formula (I) to (IV) 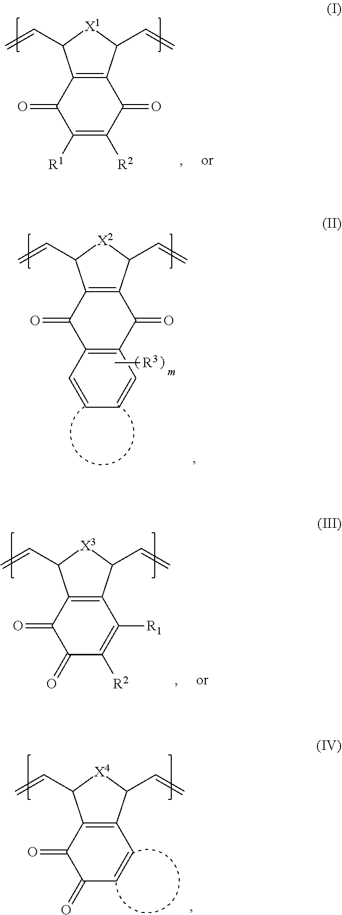
wherein in Formulas (I) to (IV),
X¹ is —CH₂— or —O—;
X² is —CH₂— or —O—;
X³ is —CH₂— or —O—;
X⁴ is —CH₂— or —O—;
R¹ and R² are independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group;
R³ is independently at each occurrence hydrogen, halogen, a substituted or unsubstituted C₁₋₆ alkyl group, a substituted or unsubstituted C₁₋₃₀ alkoxy group, a poly(C₁₋₃₀ alkylene oxide) group, a substituted or unsubstituted C₃₋₃₀ cycloalkyl group, a substituted or unsubstituted C₆₋₃₀ aryl group, a substituted or unsubstituted C₆₋₃₀ heteroaryl group, a nitrile group, a nitro group, a thiol group, an amine group, an amide group, an ester group, or a ketone group;
m is 2 to 4; and
the dashed lines of Formula (II) and (IV) indicate the optional presence of one or more additional fused substituted or unsubstituted aryl groups.

20. The composite of claim 19, wherein the substrate comprises a carbonaceous material.

21. The composite of claim 19, wherein the quinone-containing polymer is at least partially crosslinked.

22. An electrode assembly comprising:
a porous separator; and
the composite of claim 19 on a surface of the porous separator, in a pore of the porous separator, or a combination thereof.

23. An electrochemical cell comprising
a first electrode comprising the composite of claim 19;
a second electrode comprising a complementary electroactive layer; and
a first separator between the first electrode and the second electrode.

24. (canceled)

25. The electrochemical cell of claim 23, wherein the composite further comprises an electrolyte.

26. A gas separation system comprising a plurality of electrochemical cells in fluid communication with a gas inlet and a gas outlet, wherein each of the plurality of electrochemical cells is according to claim 23.

27. The gas separation system of claim 26, wherein the gas separation system further comprises a contactor unit in fluid contact with a gas mixture, wherein the contactor unit is in fluid communication with an electrolyte.

28. (canceled)

29. An electrochemical cell comprising the quinone-containing polymer of claim 1.

30. The electrochemical cell of claim 29, comprising:
a first electrode;
a second electrode;
a separator between the first electrode and the second electrode; and
an electrolyte contacting at least one of the first electrode or the second electrode, wherein at least one of the first electrode, the second electrode, the separator, or the electrolyte comprises the quinone-containing polymer.

31. The electrochemical cell of claim 30, wherein the electrolyte comprises the quinone-containing polymer.

32. A gas separation system comprising: the electrochemical cell according to claim 31, wherein the electrochemical cell is in fluid communication with a gas inlet and a gas outlet, and the electrolyte comprising the quinone-containing polymer is in fluid contact with a gas mixture, optionally further comprising a contactor unit separate from the electrochemical ceil and in which the electrolyte contacts the gas mixture.

33. (canceled)

34. (canceled)

35. The gas separation system of claim 32, comprising a plurality of the electrochemical cells.

36. An energy storage device comprising the quinone-containing polymer of claim 1.

37. An energy storage device comprising the composite of claim 19, optionally wherein the energy gorge device comprises a plurality of the electrochemical cells.

38. (canceled)

39. An energy storage device comprising the electrochemical cell of claim 23.

40. An electrochromic device comprising the quinone-containing polymer of claim 1.

41. An electrochromic device comprising the composite of claim 19.

42. An electrochromic device comprising the electrochemical cell of claim 23.

43. A method for separating a target gas from a fluid mixture comprising the target gas, the method comprising:
contacting the fluid mixture with a quinone-containing polymer comprising repeating units according to Formulas (I) to (IV), wherein the quinone-containing polymer is in a reduced state, to form an anion adduct between the target gas and the quinone-containing polymer in the reduced state.
